(19) United States
(12) Patent Application Publication
(10) Pub. No.: US 2023/0018477 A1
(43) Pub. Date: Jan. 19, 2023

(54) COMPOSITE BODY, LITHIUM ION CONDUCTOR, ALL-SOLID STATE LITHIUM ION SECONDARY BATTERY, ELECTRODE SHEET FOR ALL-SOLID STATE LITHIUM ION SECONDARY BATTERY, AND LITHIUM TETRABORATE

(71) Applicants: FUJIFILM Corporation, Tokyo (JP); TOKYO INSTITUTE OF TECHNOLOGY, Tokyo (JP)

(72) Inventors: Yukihiro OKUNO, Kanagawa (JP); Yosuke SHIRATORI, Kanagawa (JP); Shintaro YASUI, Tokyo (JP); Mitsuru ITOH, Tokyo (JP)

(73) Assignees: FUJIFILM Corporation, Tokyo (JP); TOKYO INSTITUTE OF TECHNOLOGY, Tokyo (JP)

(21) Appl. No.: 17/946,025

(22) Filed: Sep. 15, 2022

Related U.S. Application Data
(63) Continuation of application No. PCT/JP2021/010433, filed on Mar. 15, 2021.

(30) Foreign Application Priority Data
Mar. 23, 2020 (JP) 2020-051334
Dec. 2, 2020 (JP) 2020-200180

(51) Int. Cl. H01M 10/0562; H01M 4/62; H01M 10/0585; H01M 10/0525; C04B 35/50

(52) U.S. Cl. CPC H01M 10/0562; H01M 4/62; H01M 10/0585; H01M 10/0525; C04B 35/50; H01M 2300/0071; H01M 2004/021

(57) ABSTRACT

According to the present invention, there are provided a composite body that enables the formation of a lithium ion conductor that exhibits good lithium ion conductivity by a pressurization treatment without sintering at a high temperature (about 1,000° C.) while using a lithium-containing oxide having excellent safety and stability, as well as a lithium ion conductor, an all-solid state lithium ion secondary battery, an electrode sheet for an all-solid state lithium ion secondary battery, and lithium tetraborate. The composite body according to the embodiment of the present invention contains a lithium compound having a lithium ion conductivity of 1.0×10⁻⁶ S/cm or more at 25° C. and lithium tetraborate that satisfies the following requirement 1.

The requirement 1: In a reduced two-body distribution function G(r) obtained from an X-ray total scattering measurement of the lithium tetraborate, a first peak in which a peak top is located in a range where r is 1.43±0.2 Å and a second peak in which a peak top is located in a range where r is 2.40±0.2 Å are present, G(r) of the peak top of the first peak and G(r) of the peak top of the second peak indicate more than 1.0, and an absolute value of G(r) is less than 1.0 in a range where r is more than 5 Å and 10 Å or less.

### CROSS-REFERENCE TO RELATED APPLICATIONS

This application is a Continuation of PCT International Application No. PCT/JP2021/010433 filed on Mar. 15, 2021, which claims priority under 35 U.S.C. § 119(a) to Japanese Patent Application No. 2020-051334 filed on Mar. 23, 2020 and Japanese Patent Application No. 2020-200180 filed on Dec. 2, 2020. Each of the above applications is hereby expressly incorporated by reference, in its entirety, into the present application.

### BACKGROUND OF THE INVENTION

### 1. Field of the Invention

The present invention relates to a composite body, a lithium ion conductor, an all-solid state lithium ion secondary battery, an electrode sheet for an all-solid state lithium ion secondary battery, and lithium tetraborate.

### 2. Description of the Related Art

In the related art, a liquid electrolyte having high lithium ion conductivity has been used in a lithium ion secondary battery. However, since the liquid electrolyte is flammable, there is a problem in safety. In addition, since it is in a liquid state, it is difficult to make it compact, and in a case where a battery becomes large, there is also a problem of limitation on capacity.

On the other hand, the all-solid state lithium ion secondary battery is one of the next-generation batteries that can solve these problems. In the all-solid state battery, a solid electrolyte having good lithium c is required in order to obtain desired charging and discharging characteristics. For example, JP2013-140762A discloses a solid electrolyte that can be used in an all-solid state lithium ion secondary battery. JP2013-140762A discloses a solid electrolyte based on a lithium-containing oxide.

### SUMMARY OF THE INVENTION

On the other hand, in a case where such a lithium-containing oxide as described in JP2013-140762A is used, a high-temperature baking treatment of about 1,000° C. is required for molding, and there is room for improvement in terms of productivity.

Accordingly, in a case where there is a material that enables the formation of a lithium ion conductor that exhibits good lithium ion conductivity by a pressurization treatment without sintering at a high temperature while using a lithium-containing oxide having excellent safety and stability, a safe and stable solid electrolyte can be produced with high productivity, which is desirable.

In consideration of the above circumstances, an object of the present invention is to provide a composite body that enables the formation of a lithium ion conductor that exhibits good lithium ion conductivity by a pressurization treatment without sintering at a high temperature (about 1,000° C.) while using a lithium-containing oxide having excellent safety and stability,

In addition, another object of the present invention is to provide a lithium ion conductor, an all-solid state lithium ion secondary battery, an electrode sheet for an all-solid state lithium ion secondary battery, and lithium tetraborate.

As a result of diligent studies to solve the above-described problems, the inventors of the present invention have completed the present invention having the following aspects.

(1) A composite body comprising:

a lithium compound having a lithium ion conductivity of 1.0×10⁻⁶ S/cm or more at 25° C.; and

lithium tetraborate that satisfies a requirement 1 described later.

(2) The composite body according to (1), in which a proportion of a full width at half maximum of a peak in which a chemical shift appears in a range of −100 to +100 ppm in a spectrum obtained in a case where a solid ⁷Li-NMR measurement of the lithium tetraborate is carried out at 120° C. is 70% or less with respect to a full width at half maximum of a peak in which a chemical shift appears in a range of −100 to +100 ppm in a spectrum obtained in a case where the solid ⁷Li-NMR measurement of the lithium tetraborate is carried out at 20° C.

(3) The composite body according to (1) or (2), in which the lithium tetraborate has a bulk elastic modulus of 45 GPa or less.

(4) The composite body according to any one of (1) to (3), in which the lithium compound is a lithium-containing oxide.

(5) The composite body according to any one of (1) to (4), in which the lithium compound includes at least one selected from the group consisting of a lithium compound having a garnet-type structure or a garnet-type similar structure containing at least Li, La, Zr, and O; a lithium compound having a perovskite-type structure, containing at least Li, Ti, La, and O; a lithium compound having a NASICON-type structure, containing at least Li, M¹, P, and O, where M¹ represents at least one of Ti, Zr, or Ge; a lithium compound having an amorphous-type structure, containing at least Li, P, O, and N; a lithium compound having a monoclinic structure, containing at least Li, Si, and O; a lithium compound having an olivine-type structure represented by LiM²X¹O₄, where M² represents a divalent element or a trivalent element, X¹ represents a pentavalent element in a case where M² represents a divalent element, and X¹ represents a tetravalent element in a case where M² represents a trivalent element; a lithium compound having an antiperovskite structure, containing at least Li, O, and X², where X² represents at least one of Cl, Br, or N; a lithium compound having a spinel-type structure, represented by Li₂M³Y₄, where M³ represents at least one of Cd, Mg, Mn, or V, and Y represents at least one of F, Cl, Br, or I; and a lithium compound having a β-alumina structure.

(6) A lithium ion conductor formed of the composite body according to any one of (1) to (5).

(7) The lithium ion conductor according to (6),

wherein the lithium ion conductor satisfies a requirement 2 or a requirement 3, described later.

(8) An all-solid state lithium ion secondary battery comprising, in the following order:

a positive electrode active material layer;

a solid electrolyte layer; and

a negative electrode active material layer,

in which at least one of the positive electrode active material layer, the solid electrolyte layer, or the negative electrode active material layer contains the lithium ion conductor according to (6) or (7).

(9) An electrode sheet for an all-solid state lithium ion secondary battery comprising the lithium ion conductor according to (6) or (7).

(10) Lithium tetraborate that satisfies a requirement 1 described later.

(11) The lithium tetraborate according to (10), in which a proportion of a full width at half maximum of a peak in which a chemical shift appears in a range of −100 to +100 ppm in a spectrum obtained in a case where a solid ⁷Ni-NMR measurement is carried out at 120° C. is 70% or less with respect to a full width at half maximum of a peak in which a chemical shift appears in a range of −100 to +100 ppm in a spectrum obtained in a case where the solid ⁷Li-NMR measurement is carried out at 20° C.

(12) The lithium tetraborate according to (10) or (11), in which a coefficient of determination obtained by carrying out a linear regression analysis according to a least squares method in a wave number range of 600 to 850 cm⁻¹ is 0.9400 or more in a Raman spectrum.

According to the present invention, it is possible to provide a composite body that enables the formation of a lithium ion conductor having high lithium ion conductivity by solely pressurization without sintering at a high temperature (about 1,000° C.) while using a lithium-containing oxide having excellent safety and stability,

Further, according to the present invention, it is possible to provide a lithium ion conductor, an all-solid state lithium ion secondary battery, an electrode sheet for an all-solid state lithium ion secondary battery, and lithium tetraborate.

### BRIEF DESCRIPTION OF THE DRAWINGS

FIG. 1 is a graph showing an example of a reduced two-body distribution function G(r) obtained by an X-ray total scattering measurement of a second lithium compound.

FIG. 2 is a graph showing an example of an X-ray total scattering profile of the second lithium compound.

FIG. 3 is a graph showing an example of a structural factor S(Q) based on the X-ray total scattering profile obtained in FIG. 2.

FIG. 4 is a view showing an example of a spectrum obtained in a case where a solid ⁷Li-NMR measurement of the second lithium compound is carried out at 20° C. or 120° C.

FIG. 5 is a view showing an example of a spectrum obtained in a case where a solid ⁷Li-NMR measurement of a lithium tetraborate crystal is carried out at 20° C. or 120° C.

FIG. 6 is a graph showing an example of a Raman spectrum of the second lithium compound.

FIG. 7 is a graph showing a Raman spectrum of a general lithium tetraborate crystal.

FIG. 8 is a graph showing an example of Raman spectra of a first lithium compound and the second lithium compound in a lithium ion conductor.

FIG. 9 is a cross-sectional view schematically illustrating an all-solid state lithium ion secondary battery according to a preferred embodiment of the present invention.

### DESCRIPTION OF THE PREFERRED EMBODIMENTS

Hereinafter, the present invention will be described in detail.

A numerical value range represented using “to” in the present specification means a range including the numerical values described before and after “to” as the lower limit and the upper limit respectively.

In addition, in the present specification, the expression of a compound (for example, in a case where a compound is represented by an expression with “compound” added to the end) refers to not only the compound itself but also a salt or an ion thereof. In addition, this expression also refers to a derivative obtained by modifying a part of the compound, for example, by introducing a substituent into the compound within a range where the effects of the present invention are not impaired.

A feature point of a composite body according to the embodiment of the present invention is that a lithium compound that exhibits a predetermined lithium ion conductivity and lithium tetraborate that exhibits predetermined characteristics are used in combination. As will be described later, although a lithium tetraborate that exhibits predetermined characteristics has a short-distance ordered structure, it has almost no long-distance ordered structure. As a result, the obtained lithium tetraborate is softer than the lithium-containing oxide in the related art and exhibits a characteristic of being easily plastically deformed. In a case where a composite body containing such lithium tetraborate and a lithium compound having high lithium ion conductivity is subjected to a pressurization treatment, the lithium tetraborate plays a role of connecting lithium compounds to each other while being plastically deformed between the lithium compounds, and thus it is possible to easily obtain a lithium ion conductor having a low void ratio and exhibiting good lithium ion conductivity.

It is noted that there is, as the related art, an aspect in which a lithium halide is used instead of the lithium tetraborate that exhibits predetermined characteristics and is used in the present invention; however, a lithium halide represented by lithium iodide is easily oxidized and decomposed in a case where the air is present, and thus more specialized equipment is required in the manufacturing process of an all-solid state lithium ion secondary battery. In addition, it is difficult to be used on a positive electrode side of a battery due to the oxidation reaction of the lithium halide.

Further, as the related art, although a sulfide-based lithium compound can be also mentioned as a lithium compound that is easily plastically deformed, there is a concern that hydrogen sulfide is generated in the case of this compound.

The composite body according to the embodiment of the present invention includes a lithium compound in which the lithium ion conductivity is 1.0×10⁻⁶ S/cm or more at 25° C. (hereinafter, also simply referred to as a “first lithium compound”) and a lithium tetraborate (hereinafter, also simply referred to as a “second lithium compound”) that satisfies a predetermined requirement.

In the following description, each component contained in the composite body will be described in detail.

<First Lithium Compound>

The composite body contains a lithium compound (the first lithium compound) in which the lithium ion conductivity is 1.0×10⁻⁶ S/cm or more at 25° C. In a case where the composite body contains the first lithium compound, a lithium ion conductor obtained by using the composite body exhibits excellent lithium ion conductivity.

The kind of the first lithium compound is not particularly limited, and it suffices that the lithium ion conductivity is 1.0×10⁻⁶ S/cm or more at 25° C. The lithium ion conductivity of the first lithium compound is preferably 1.0×10⁻⁵ S/cm or more at 25° C. The upper limit thereof is not particularly limited, and it is 1.0×10⁻³ S/cm or less in a large number of cases.

In the measuring method for lithium ion conductivity, Au electrodes are arranged above and below the first lithium compound, measurement is carried out at a measurement temperature of 25° C., an applying voltage of 100 mV, and a measurement frequency range of 1 Hz to 1 MHz, and then the lithium ion conductivity is calculated from the arc diameter of the Cole-Cole plot obtained by measuring the alternating current impedance.

The first lithium compound is preferably a compound selected from the group consisting of the following compounds 1 to 9 from the viewpoint that the lithium ion conductivity of the lithium ion conductor that is obtained by subjecting the composite body to pressurization molding is more excellent (hereinafter, also simply referred to as “the effect of the present invention is more excellent”).

Compound 1: A lithium compound having a garnet-type structure or a garnet-type similar structure containing at least Li, La, Zr, and O

Compound 2: A lithium compound having a perovskite-type structure, containing at least Li, Ti, La, and O

Compound 3: A lithium compound having a NASICON-type structure, containing at least Li, M¹, P, and O, where M¹ represents at least one of Ti, Zr, Si, or Ge

Compound 4: A lithium compound having an amorphous-type structure, containing at least Li, P, O, and N

Compound 5: A lithium compound having a monoclinic structure, containing at least Li, Si, and O

Compound 6: A lithium compound having an olivine-type structure represented by LiM²X¹O₄, where M² represents a divalent element or a trivalent element, X¹ represents a pentavalent element in a case where M² represents a divalent element, and X¹ represents a tetravalent element in a case where M² represents a trivalent element

Examples of the divalent element represented by M² include Mg, Ca, Sr, Ba, and Zn, and examples of the trivalent element represented by M² include Al, Ga, In, Sc, Nd, and Tm. Further, examples of the pentavalent element represented by X¹ include P, As, and Sb, and examples of the tetravalent element represented by X¹ include Si and Ge.

Compound 7: A lithium compound having an antiperovskite structure, containing at least Li, O, and X², where X² represents at least one of Cl, Br, or N

Compound 8: A lithium compound having a spinel-type structure, represented by Li₂M³Y₄, where M³ represents at least one of Cd, Mg, Mn, or V, and Y represents at least one of F, Cl, Br, or I.

Compound 9: A lithium compound having a β-alumina structure.

Elements of the compound 1 include Li₇La₃Zr₂O₁₂ (hereinafter, also referred to as “LLZO”) and those obtained by doping LLZO with an element such as Ta, Al, Ga, Nb, Ba, Rb, Sc, or Y.

Examples of the compound 2 include Li₃ₓLa_{2/3-x}TiO₃ and those obtained by doping Li₃ₓLa_{2/3-x}TiO₃ with an element such as Sr, Zr, or Hf.

Examples of the compound 3 include LiGe₂(PO₄)₃ and LiTi₂(PO₄)₃, as well as those obtained by doping them with an element such as Si, Al, or Cr.

Examples of the compound 4 include LiPON (LiₓPO_{y}N_{z}, x=2y+3z−5).

Examples of the monoclinic structure in the compound 5 include a NASICON-type structure and a garnet-type structure. Examples of the compound 5 include Li₄SiO₄ and those obtained by doping Li₄SiO₄ with an element such as Zn, Cr, Sn, Zr, or Al. Further, the compound 5 (particularly, Li₄SiO₄) is preferably a compound of which the space group is designated as P12₁/ml.

Examples of the compound 6 include LiInSiO₄, LiInGeO₄, LiScGeO₄, and LiMgAsO₄.

Examples of the compound 7 include Li₃OCl and Li₃OCl_{0.5}Br_{0.5}, as well as those obtained by doping them with an element such as Ba or Sr.

Examples of the compound 8 include Li₂CdCl₄, Li₂MgCl₄, Li₂MnCl₄, and Li₂VCl₄.

Examples of the compound 9 include a Li compound such as Li-β-alumina having a composition represented as (Li₂O)ₓ.11Al₂O₃, where x has a value of, for example, 0.9 to 1.3.

Among them, the first lithium compound is preferably a lithium-containing oxide. The lithium-containing oxide means an oxide containing a lithium element.

The bulk elastic modulus of the first lithium compound is not particularly limited; however, it is preferably 50 to 300 GPa and more preferably 100 to 200 GPa from the viewpoint that the effect of the present invention is more excellent.

The bulk elastic modulus is measured according to the ultrasonic attenuation method.

Specifically, first, a suspension in which the first lithium compound is purely suspended is prepared. The content of the first lithium compound in the suspension is set to 1.2% by mass with respect to the total mass of the suspension. Next, the ultrasonic attenuation spectrum of the suspension is measured, and the bulk elastic modulus of the first lithium compound is determined from the fitting according to the scattering attenuation theoretical expression. It is noted that in a case where the above fitting is carried out, the particle size distribution, density, and Poisson's ratio of the first lithium compound are used. For example, in a case of LLZO, the density is 4.97 g/ml, and the Poisson's ratio is 0.257.

Regarding the fitting according to the above-described scattering attenuation theoretical expression, the bulk elastic modulus is calculated by using the expressions (7), (12), and (13) described in Kohjiro Kubo et al., Ultrasonics 62 (2015) 186-194.

Further, for the particle size distribution of the first lithium compound, a particle image is acquired according to a flow-type particle image analysis method to obtain a histogram (a particle size distribution) of the particle diameter of the first lithium compound. The particle diameter corresponds to a circle-equivalent diameter.

The median diameter (D50) of the first lithium compound is not particularly limited; however, it is preferably 0.1 to 100 μm and more preferably 1 to 20 μm from the viewpoint that the effect of the present invention is more excellent.

In the above-described measuring method for an average particle diameter, a particle image is acquired according to a flow-type particle image analysis method, the particle diameter distribution of the first lithium compound is calculated, and the average particle diameter is analyzed from the obtained distribution.

The first lithium compound may be produced by a known method, or a commercially available product may be used.

The content of the first lithium compound in the composite body is not particularly limited; however, it is preferably 50% to 97% by mass and more preferably 70% to 95% by mass with respect to the total mass of the composite body from the viewpoint that the effect of the present invention is excellent and the viewpoint that the processing and molding of the composite body is more excellent.

<Second Lithium Compound>

The composite body contains lithium tetraborate (a second lithium compound) that satisfies a requirement 1 described later. As described above, the second lithium compound is easily plastically deformed, and as a result, the processing moldability of the composite body is improved.

The second lithium compound (the lithium tetraborate) contained in the composite body according to the embodiment of the present invention is generally a compound represented by Li₂B₄O₇, and it is a compound mainly composed of Li, B, and O; however, in the present invention, it may deviate from the above standard value. More specifically, the second lithium compound contained in the composite body according to the embodiment of the present invention is preferably a compound represented by Li₂₊ₓB_{4+y}O_{7+z} (−0.3<x<0.3, −0.3<y<0.3, and −0.3<z<0.3).

Further, the second lithium compound may be doped with an element other than Li, B, and O. That is, the second lithium compound may be lithium tetraborate which may be doped with an element selected from the group consisting of C, Si, P, S, Se, Ge, F, Cl, Br, I, N, Al, Ga, and In. As a result, the second lithium compound may be a compound represented by Li₂₊ₓB_{4+y}O_{7+z} (−0.3<x<0.3, −0.3<y<0.3, and −0.3<z<0.3), which may be doped with an element selected from the group consisting of C, Si, P, S, Se, Ge, F, Cl, Br, I, N, Al, Ga, and In.

The second lithium compound satisfies the following requirement 1.

The requirement 1: In a reduced two-body distribution function G(r) obtained from an X-ray total scattering measurement of the second lithium compound (the lithium tetraborate), a first peak in which a peak top is located in a range where r is 1.43±0.2 Å and a second peak in which a peak top is located in a range where r is 2.40±0.2 Å are present, G(r) of the peak top of the first peak and G(r) of the peak top of the second peak indicate more than 1.0, and an absolute value of G(r) is less than 1.0 in a range where r is more than 5 Å and 10 Å or less.

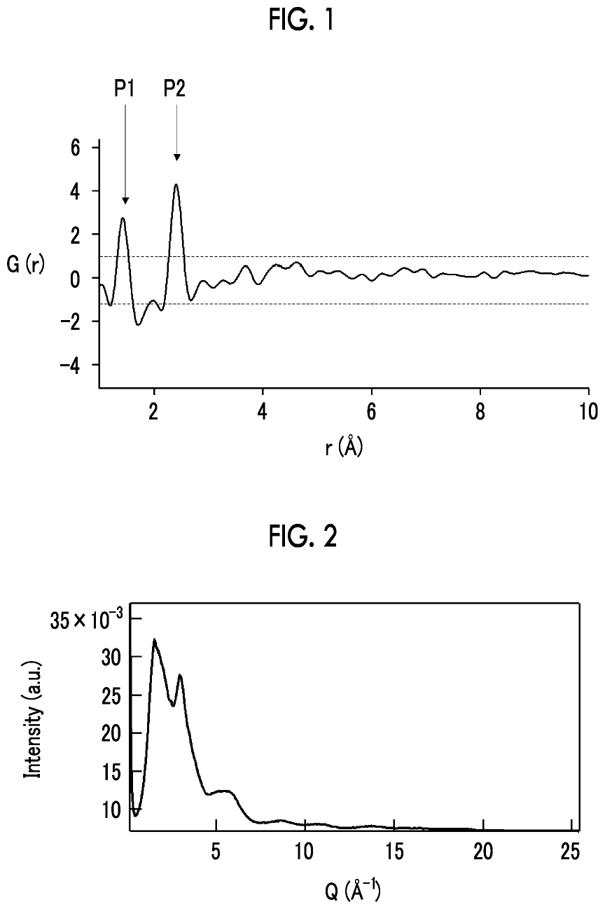

Hereinafter, the requirement 1 will be described with reference to FIG. 1.

FIG. 1 is a graph showing an example of a reduced two-body distribution function G(r) obtained by an X-ray total scattering measurement of a second lithium compound. The vertical axis of FIG. 1 is a reduced two-body distribution function obtained by subjecting X-ray scattering to Fourier transform, and it indicates the probability that an atom is present at a position of a distance r.

The X-ray total scattering measurement is carried out with SPring-8 BL04B2 (acceleration voltage: 61.4 keV, wavelength: 0.2019 Å).

It is noted that the reduced two-body distribution function G(r) is obtained by converting the scattering intensity I, which is obtained experimentally, according to the following procedure.

First, the scattering intensity I_{obs} is represented by Expression (1). Further, the structural factor S(Q) is obtained by dividing I_{coh} by the product of the number of atoms N and the atomic scattering factor f.

I_{obs}=I_{coh}+I_{incoh}+I_{fluorescence} (1)

S(Q)=I_{coh}*Nf² (2)

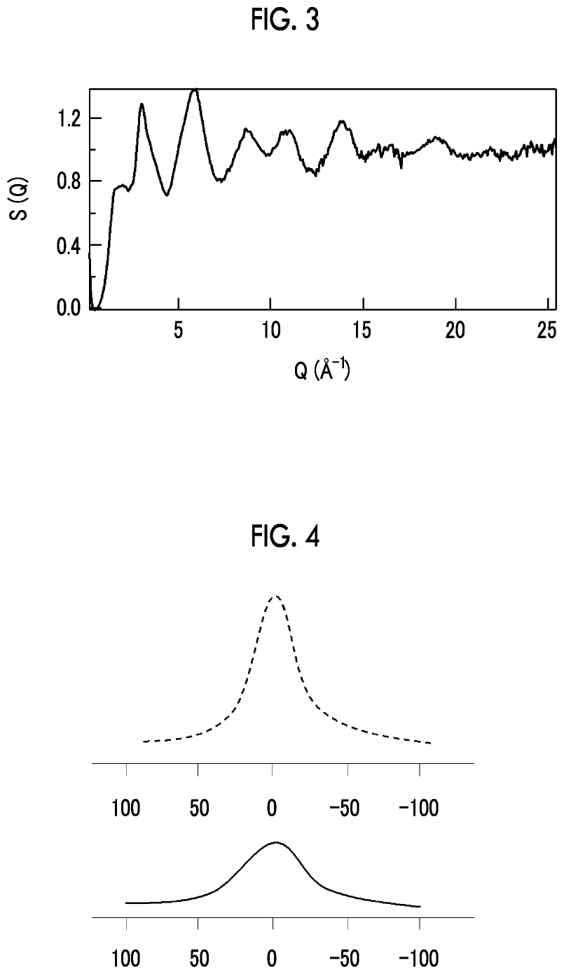

It is necessary to use the structural factor S(Q) for the pair distribution function (PDF) analysis. In Expression (2), the required intensity is solely the coherent scattering I_{coh}. Incoherent scattering I_{incoh} and the X-ray fluorescence I_{fluorescence} can be subtracted from the scattering intensity I_{obs} by a blank measurement, subtraction using a theoretical expression, and a discriminator of a detector. FIG. 2 and FIG. 3 are graphs showing an example of the results of the total scattering measurement of the second lithium compound and the extracted structural factor S(Q), respectively.

The coherent scattering is represented by Debye's scattering Expression (3) (N: total number of atoms, f: atomic scattering factor, rᵢⱼ: interatomic distance between i and j).

$${I}_{c o h} = {\sum }_{j = 1}^{N} {\sum }_{k = 1}^{N} {f}_{i} {f}_{j} \frac{sin {Qr}_{ij}}{Q {r}_{ij}} . \qquad ( 3 )$$

In a case of focusing on any atom, and the atomic density at a distance r is denoted as ρ(r), the number of atoms present inside a sphere having a radius of r to r+d(r) is 4πr⁷ρ(r)dr, and thus Expression (3) is represented by Expression (4).

I_{coh}=Nf²[1+4π∫₀^{∞}r²ρ(r)sin Qr/Qrdr] (4)

In a case where the average density of atoms is denoted as ρ₀, and Expression (4) is modified, Expression (5) is obtained.

I_{coh}/N=f²[1+4π∫₀^{∞}r²(α(r)−ρ₀)sin Qr/Qr] (5)

Expression (6) is obtained from Expression (5) and Expression (2).

4πr₂ρ(r)=4πr²ρ₀+2r/π∫₀^{∞}Q[S(Q)−1]sin QrdQ (6)

The two-body distribution function g(r) is represented by Expression (7).

g(r)=ρrᵣ/ρ₀ (7)

Expression (8) is obtained from Expression (6) and Expression (7).

g(r)=1+1/2π²ρ₀r∫₀^{∞}Q[S(Q)−1]sin QrdQ (8)

As described above, the two-body distribution function can be determined by the Fourier transform of the structural factor S(Q). The reduced two-body distribution function (FIG. 1) is obtained by converting the two-body distribution function to G(r)=4πr (g(r)−1) in order to make it easier to observe the intermediate/long-distance order. The g(r) that oscillates around 0 represents the density difference from the average density at each interatomic distance, and it is larger than the average density of 1 in a case where there is a correlation at a specific interatomic distance. As a result, it reflects the distance and coordination number of the element corresponding to the local to intermediate distance. In a case where the order is lost, ρ(r) approaches the average density, and thus G(r) approaches 1. As a result, as r is larger, the order is further lost, and thus in the amorphous structure, G(r) is 1, that is, G(r) is 0.

In the requirement 1, in the reduced two-body distribution function G(r) obtained from the X-ray total scattering measurement, a first peak P1 of which a peak top is located in a range where r is 1.43±0.2 Å and a second peak P2 of which a peak top is located in a range where r is 2.40±0.2 Å are present, and G(r) of the peak top of the first peak P1 and G(r) of the peak top of the second peak P2 indicates more than 1.0, as shown in FIG. 1.

That is, in the reduced two-body distribution function G(r) obtained from an X-ray total scattering measurement of the second lithium compound, the first peak in which G(r) of a peak top (hereinafter, also referred to as a “first peak top”) indicates more than 1.0 and the first peak top is located in a range of 1.43±0.2 Å and the second peak in which G(r) of a peak top (hereinafter, also referred to as a “second peak top”) indicates more than 1.0 and the second peak top is located in a range of 2.40±0.2 Å are observed.

It is noted that in FIG. 1, the peak top of the first peak P1 is located at 1.43 Å, and the peak top of the second peak P2 is located at 2.40 Å.

At the position of 1.43 Å, a peak attributed to the interatomic distance of boron (B)-oxygen (O) is present. In addition, at the position of 2.40 Å, a peak attributed to the interatomic distance of boron (B)-boron (B) is present. That is, the fact that the above two peaks (the first peak and the second peak) are observed means that a periodic structure corresponding to the above two interatomic distances is present in the second lithium compound.

Further, in the requirement 1, the absolute value of G(r) is less than 1.0 (corresponding to the broken line) in a range where r is more than 5 Å and 10 Å or less as shown in FIG. 1.

The fact that the absolute value of G(r) is less than 1.0 in a range where r is more than 5 Å and 10 Å or less as described above means that almost no long-distance ordered structure is not present in the second lithium compound.

The second lithium compound that satisfies the above requirement 1 has a short-distance ordered structure related to the interatomic distances of B-O and B-B as described above; however, it has almost no long-distance ordered structure. For this reason, the second lithium compound itself exhibits an elastic characteristic of easily plastically deformed, and as a result, a composite body that can be molded by a pressurization treatment or the like can be obtained.

It is noted that in the reduced two-body distribution function G(r), there may be a peak other than the first peak and the second peak in a range where r is 5 Å or less.

The second lithium compound may have a crystalline component as long as the effect of the present invention is not impaired. Among the above, the second lithium compound is preferably a compound in which in a case where it is analyzed according to the X-ray diffraction method using CuKα ray, the strongest intensity among the crystalline diffraction lines observed in a range of 20 to 25° in terms of 2θ value is preferably 5 times or less and more preferably 3 time or less with respect to the intensity of a diffraction line at the apex in a broad scattering band observed in a range of 10 to 40° in terms of 2θ value.

From the viewpoint that the effect of the present invention is more excellent, it is preferable that the second lithium compound does not have the crystalline diffraction line observed in a range of 20 to 25° in terms of 2θ value.

Further, from the viewpoint that the effect of the present invention is more excellent, the proportion of a full width at half maximum of a peak in which a chemical shift appears in a range of −100 to +100 ppm in a spectrum obtained in a case where a solid ⁷Li-NMR measurement of the second lithium compound is carried out at 120° C. is preferably 70% or less and more preferably 50% or less with respect to a full width at half maximum of a peak in which a chemical shift appears in a range of −100 to +100 ppm in a spectrum obtained in a case where the solid ⁷Li-NMR measurement of the second lithium compound is carried out at 20° C. The lower limit thereof is not particularly limited; however, it is 10% or more in a large number of cases.

The full width at half maximum (FWHM) of the peak means the width (ppm) at a point (H/2) of ½ of the height (H) of the peak.

Hereinafter, the above characteristics will be described with reference to FIG. 4.

FIG. 4 is a view showing an example of a spectrum obtained in a case where a solid ⁷Li-NMR measurement of the second lithium compound is carried out at 20° C. or 120° C.

The spectrum shown on the lower side by the solid line in FIG. 4 is a spectrum obtained in a case where the solid ⁷Li-NMR measurement has been carried out at 20° C., and the spectrum shown on the upper side by the broken line in FIG. 4 is a spectrum obtained in a case where the solid ⁷Li-NMR measurement has been carried out at 120° C.

Generally, in the solid ⁷Li-NMR measurement, in a case where the motility of Li⁺ is high, the peak that is obtained is a sharper peak. In the aspect shown in FIG. 4, in a case where the spectrum at 20° C. and the spectrum at 120° C. are compared, the spectrum at 120° C. is sharper. That is, in the second lithium compound shown in FIG. 4, it is shown that the motility of Li⁺ is high due to the presence of Li defects. It is conceived that such a second lithium compound is more excellent in the effect of the present invention since it is easily plastically deformed due to the defective structure as described above and the hopping property of Li⁺ is excellent.

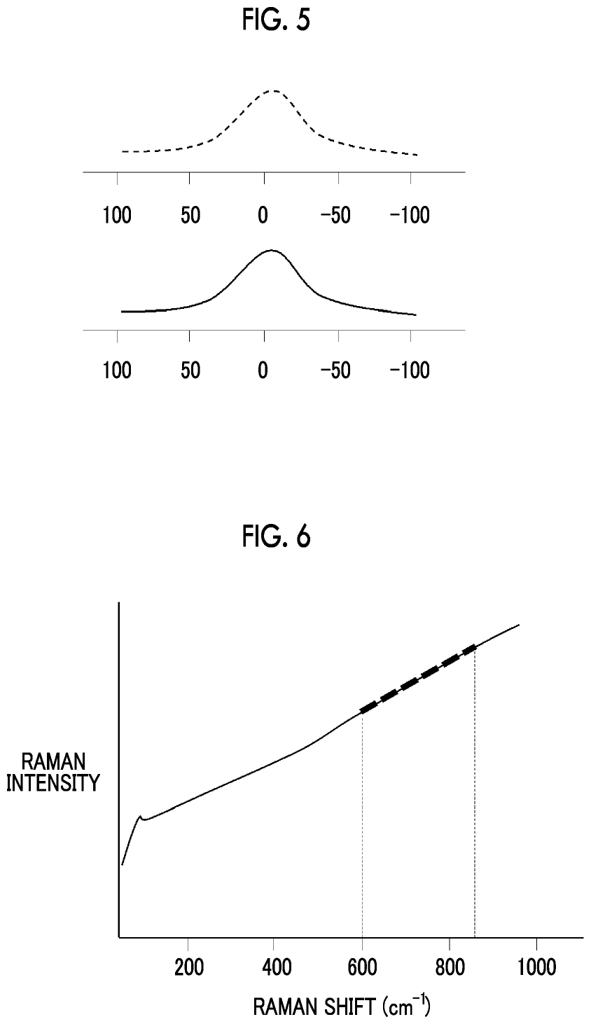

It is noted that in a case where a general lithium tetraborate crystal is subjected to the solid ⁷Li-NMR measurement at 20° C. or 120° C., the spectrum measured at 20° C. shown by the solid line, shown on the lower side of FIG. 5, and the spectrum measured at 120° C. shown by the broken line, shown on the upper side of FIG. 5 tends to have substantially the same shape. That is, the lithium tetraborate crystal has no Li defects and the like, and as a result, it has a high elastic modulus and is hardly plastically deformed.

The conditions for the above solid ⁷Li-NMR measurement conditions are as follows.

Specifically, using a 4 mm HX CP-MAS probe, a single pulse method is carried out under the following conditions, 90° pulse width: 3.2 μs, observation frequency: 155.546 MHz, observation width: 1,397.6 ppm, repetition time: 15 sec, integration: 1 time, and MAS rotation speed: 0 Hz.

Further, it is preferable that the second lithium compound satisfies the following requirement 4 from the viewpoint that the effect of the present invention is more excellent.

The requirement 4: The coefficient of determination obtained by carrying out a linear regression analysis according to a least squares method in a wave number range of 600 to 850 cm⁻¹ is 0.9400 or more in a Raman spectrum of the second lithium compound.

The coefficient of determination in the above requirement 4 is more preferably 0.9600 or more from the viewpoint that the effect of the present invention is more excellent. The upper limit thereof is not particularly limited; however, it is, for example, 1.0000.

Hereinafter, the above requirement 4 will be described with reference to FIG. 6.

FIG. 6 is a graph showing an example of a Raman spectrum of the second lithium compound. The coefficient of determination (the coefficient of determination R²) obtained by carrying out a linear regression analysis according to the least squares method is calculated in a wave number range of 600 to 850 cm⁻¹ in the Raman spectrum in which the vertical axis is the Raman intensity and the lateral axis is the Raman shift. That is, in a wave number range of 600 to 850 cm⁻¹ in the Raman spectrum of FIG. 4, a regression line (the thick broken line in FIG. 4) is determined according to the least squares method, and the coefficient of determination R² of the regression line is calculated. It is noted that as the coefficient of determination, a value between 0 (no linear correlation) and 1 (complete linear correlation of the measured values) is taken according to the linear correlation of the measured values.

In the second lithium compound, a peak is not substantially observed in a wave number range of 600 to 850 cm⁻¹ as shown in FIG. 6, and as a result, a high coefficient of determination is exhibited.

It is noted that the coefficient of determination R² corresponds to the square of the correlation coefficient (Pearson's product-moment correlation coefficient). More specifically, in the present specification, the coefficient of determination R² is calculated according to the following expression. In the expression, x₁ and y₁ respectively represent a wave number in a Raman spectrum and a Raman intensity corresponding to the wave number, x₂ represents the (arithmetic) average of the wave numbers, and y₂ represents the (arithmetic) average of the Raman intensities.

$${R}^{2} = \frac{{( \sum ( {x}_{1} - {x}_{2} ) \cdot ( {y}_{1} - {y}_{2} ) )}^{2}}{\sum ( {x}_{1} - {x}_{2} ) \cdot \sum {( {y}_{1} - {y}_{2} )}^{2}}$$

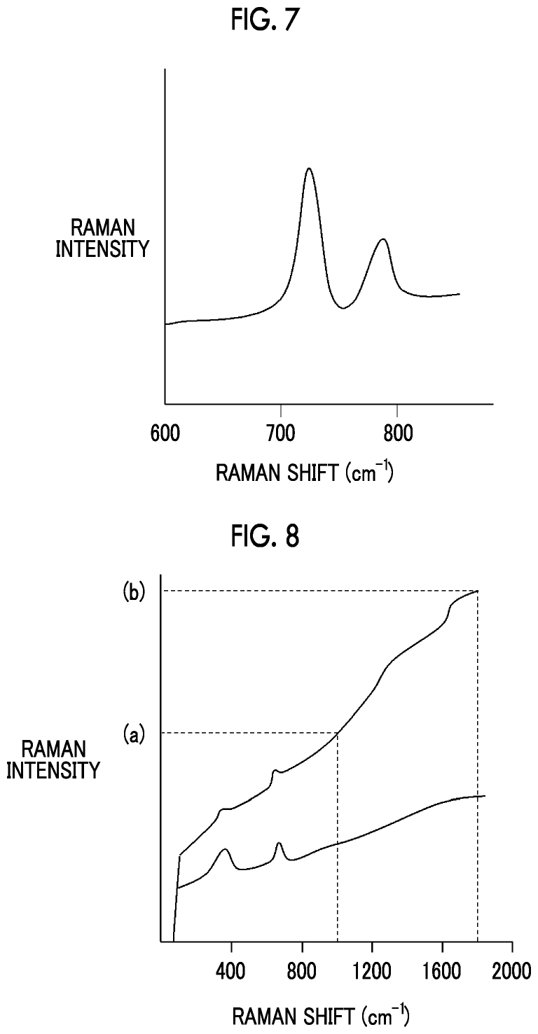

On the other hand, FIG. 7 is a graph showing a Raman spectrum of a general lithium tetraborate crystal. As shown in FIG. 7, in a case of a general lithium tetraborate crystal, peaks are observed in wave number ranges of 716 to 726 cm⁻¹ and 771 to 785 cm⁻¹ derived from the structure thereof.

In a case where there is such a peak, the coefficient of determination thereof is less than 0.9400 in a case where the coefficient of determination is calculated by carrying out a linear regression analysis according to the least squares method in a wave number range of 600 to 850 cm⁻¹.

That is, the fact that the coefficient of determination is 0.9400 or more indicates that the second lithium compound contains almost no crystal structures contained in a general lithium tetraborate crystal. Therefore, as a result, it is conceived that the second lithium compound has the characteristic of being easily plastically deformed and a characteristic of being excellent in the hopping property of Lit

Examples of the measuring method for the Raman spectrum in the above requirement 4 include a measuring method for a Raman spectrum, which is carried out in the requirement 2 described later.

The bulk elastic modulus of the second lithium compound is not particularly limited; however, it is preferably 45 GPa or less and more preferably 40 GPa or less from the viewpoint that the effect of the present invention is more excellent. The lower limit thereof is not particularly limited; however, it is preferably 5 GPa or more.

The measuring method for the bulk elastic modulus is the same as the measuring method for the bulk elastic modulus of the first lithium compound.

The median diameter (D50) of the second lithium compound is not particularly limited; however, it is preferably 0.05 to 8.0 μm, more preferably 0.5 to 4.0 μm, and still more preferably 0.1 to 2.0 μm, from the viewpoint that the effect of the present invention is more excellent.

The measuring method for the median diameter is the same as the measuring method for the median diameter of the first lithium compound.

The production method for the second lithium compound is not particularly limited, and it is not particularly limited as long as lithium tetraborate that exhibits the above-described characteristics can be obtained.

Among the above, examples thereof include a method of subjecting a lithium tetraborate crystal to a mechanical milling treatment can be mentioned from the viewpoint that the second lithium compound can be produced with high productivity.

The lithium tetraborate crystal (the LBO crystal) to be used shall be an LBO crystal in which an XRD pattern attributed to a space group I41cd is observed among the lithium tetraborate in a case where an XRD measurement is carried out.

The mechanical milling treatment is a treatment of pulverizing a sample while applying mechanical energy.

Examples of the means for the mechanical milling treatment include a ball mill, a vibration mill, a turbo mill, and a disc mill, where a ball mill is preferable since the second lithium compound can be produced with high productivity. Examples of the ball mill include a vibration ball mill, a rotary ball mill, and a planetary ball mill, where a planetary ball mill is more preferable.

As the conditions for ball milling, the optimum conditions are selected depending on the raw materials to be used.

The material of the pulverization balls (the media) to be used at the time of ball milling is not particularly limited. However, examples thereof include agate, silicon nitride, zirconia, alumina, and an iron-based alloy, where zirconia is preferable from the viewpoint that the second lithium compound can be produced with high productivity.

The average particle diameter of the pulverization balls is not particularly limited; however, it is preferably 1 to 10 mm and more preferably 3 to 7 mm from the viewpoint that the second lithium compound can be produced with high productivity. The average particle diameter is a value obtained by measuring the diameters of any 50 pulverization balls and arithmetically averaging them. In a case where the pulverization ball is not spherical, the major axis shall be taken as the diameter.

The number of pulverization balls used at the time of ball milling is not particularly limited; however, it is preferably 10 to 100 and more preferably 40 to 60 from the viewpoint that the second lithium compound can be produced with high productivity.

The material of the pulverization pot to be used at the time of ball milling is not particularly limited. However, examples thereof include agate, silicon nitride, zirconia, alumina, and an iron-based alloy, where zirconia is preferable from the viewpoint that the second lithium compound can be produced with high productivity.

The rotation speed in a case of carrying out ball milling is not particularly limited; however, it is preferably 200 to 700 rpm and more preferably 350 to 550 rpm from the viewpoint that the second lithium compound can be produced with high productivity.

The treatment time of ball milling is not particularly limited; however, it is preferably 10 to 200 hours and more preferably 20 to 140 hours from the viewpoint that the second lithium compound can be produced with high productivity.

The atmosphere in a case of carrying out ball milling may be an atmosphere of atmospheric air or may be an atmosphere of an inert gas (for example, argon, helium, or nitrogen).

The content of the second lithium compound in the composite body is not particularly limited; however, it is preferably 3% to 50% by mass and more preferably 5% to 30% by mass with respect to the total mass of the composite body from the viewpoint that the lithium ion conductivity of the lithium ion conductor that is obtained by using the composite is more excellent and the viewpoint that the processing and molding of the composite body is more excellent.

The mixing ratio of the first lithium compound and the second lithium compound in the composite body is not particularly limited. However, the quantity ratio of content between the second lithium compound and the first lithium compound (the mass of the second lithium compound/the mass of the first lithium compound) is not particularly limited; however, it is preferably 1/20 to 1/1, more preferably 1/20 to 1/2, and still more preferably 1/16 to 1/3 from the viewpoint that the effect of the present invention is more excellent.

<Other Materials>

The composite body may contain other components other than the above-described first lithium compound and the second lithium compound.

The composite body may include a binder.

Examples of the binder include various organic polymeric compounds (polymers).

The organic polymeric compound that constitutes the binder may have a particle shape or may have a non-particle shape. The particle diameter (the volume average particle diameter) of the particle-shaped binder is preferably 10 to 1,000 nm, more preferably 20 to 750 nm, still more preferably 30 to 500 nm, and still more preferably 50 to 300 nm.

The kind of this binder is not particularly limited, and examples thereof include the following polymers.

Examples of the fluorine-containing polymer include polytetrafluoroethylene, polyvinylene difluoride, and a copolymer of polyvinylene difluoride and hexafluoropropylene.

Examples of the hydrocarbon-based thermoplastic polymer include polyethylene, polypropylene, styrene butadiene rubber, hydrogenated styrene butadiene rubber, butylene rubber, acrylonitrile butadiene rubber, polybutadiene, and polyisoprene.

Examples of the acrylic polymer include various (meth)acrylic monomers, (meth)acrylamide monomers, and copolymers (preferably, a copolymer of acrylic acid and methyl acrylate) of monomers constituting these polymers.

In addition, copolymers with other vinyl monomers are also preferably used. Examples of the copolymers include a copolymer of methyl (meth)acrylate and styrene, a copolymer of methyl (meth)acrylate and acrylonitrile, and a copolymer of butyl (meth)acrylate, acrylonitrile, and styrene.

Examples of other polymers include polyurethane, polyurea, polyamide, polyimide, polyester, polyether, polycarbonate, and a cellulose derivative.

Among them, an acrylic polymer, polyurethane, polyamide, or polyimide is preferable.

As the polymer that constitutes a binder, a polymer synthesized according to a conventional method may be used, or a commercially available product may be used.

One kind of binder may be used singly, or two or more kinds thereof may be used in combination.

In a case where the composite body contains a binder, the content of the binder is preferably 0.1% to 3% by mass and more preferably 0.5% to 1% by mass with respect to the total mass of the composite body.

The composite body may contain a lithium salt.

The lithium salt is not particularly limited, and it is preferably, for example, the lithium salt described in paragraphs 0082 to 0085 of JP2015-088486A.

Specific examples of the lithium salt include the following salts.

Inorganic lithium salt (L-1): An inorganic fluoride salt such as LiPF₆, LiBF₄, LiAsF₆, or LiSbF₆; a perhalogenate such as LiClO₄, LiBrO₄, or LiIO₄; an inorganic chloride salt such as LiAlCl₄.

Fluorine-containing organic lithium salt (L-2): a perfluoroalkane sulfonate such as LiCF₃SO₃; a perfluoroalkanesulfonylimide salt such as LiN(CF₃SO₂)₂, LiN(CF₃CF₂SO₂)₂, LiN(FSO₂)₂, or LiN(CF₃SO₂)(C₄F₉SO₂); a perfluoroalkane sulfonylmethide salt such as LiC(CF₃SO₂)₃; a fluoroalkyl fluorophosphate such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], or Li[PF₃(CF₂CF₂CF₂CF₃)₃].

Oxalatoborate salt (L-3): lithium bis(oxalato)borate or lithium difluorooxalato borate.

In addition to the above, examples thereof include LiF, LiCl, LiBr, LiI, Li₂SO₄, LiNO₃, Li₂CO₃, CH₃COOLi, LiAsF₆, LiSbF₆, LiAlCl₄, and LiB(C₆H₅)₄.

Among these, LiPF₆, LiBF₄, LiAsF₆, LiSbF₆, LiClO₄, Li(R^{f1}SO₃), LiN(R^{f1}SO₂)₂, LiN(FSO₂)₂, or LiN(R^{f1}SO₂)(R^{f2}SO₂) is preferable, and LiPF₆, LiBF₄, LiN(R^{f1}SO₂)₂, LiN(FSO₂)₂, or LiN(R^{f1}SO₂)(R^{f2}SO₂) is more preferable.

Here, R^{f1} and R^{f2} each independently represent a perfluoroalkyl group.

The lithium salt may be used singly, or two or more kinds thereof may be randomly combined.

In a case where the composite body contains a lithium salt, the content of the lithium salt is preferably 0.1% by mass or more, more preferably 0.5% by mass or more, and it is preferably 10% by mass or less, more preferably 5% by mass or less, still more preferably 3% by mass or less, and particularly preferably 1% by mass or less, with respect to the total mass of the composite body.

The composite body may contain another lithium compound other than the first lithium compound and the second lithium compound.

Further, the composite body may contain a solid electrolyte other than the first lithium compound and the second lithium compound.

<Lithium Ion Conductor>

The lithium ion conductor according to the embodiment of the present invention (hereinafter, also simply referred to as the “specific conductor”) is formed of the above-described composite body.

The forming method for the specific conductor by using the composite body is not particularly limited; however, examples thereof generally include a method of subjecting a composite body to a pressurization treatment to form the specific conductor. That is, the lithium ion conductor according to the embodiment of the present invention is preferably a lithium ion conductor formed by subjecting a composite body to a pressurization treatment (a pressurization molding treatment).

Hereinafter, the pressurization treatment method will be described in detail.

The method for pressurization treatment is not particularly limited, and examples thereof include a method using a known press device.

The pressurizing force at the time of the pressurization treatment is not particularly limited, and the optimum pressure is selected depending on the components in the composite body; however, it is preferably 5 to 1,500 MPa and more preferably 10 to 600 MPa from the viewpoint that the effect of the present invention is more excellent.

The time of the pressurization treatment is not particularly limited; however, it is preferably 0.01 to 0.5 hours and more preferably 0.1 to 0.2 hours from the viewpoint that the effect of the present invention is more excellent and the viewpoint of productivity.

Further, a heating treatment may be carried out at the time of the pressurization treatment. The heating temperature at the time of the heating treatment is not particularly limited; however, it is preferably 40° C. to 400° C. and more preferably 200° C. to 350° C. The heating time at the time of the heating treatment is preferably 1 minute to 6 hours.

The atmosphere during the pressurization is not particularly limited, and examples thereof include an atmosphere of atmospheric air, an atmosphere of dried air (the dew point: −20° C. or lower), and an atmosphere of inert gas (for example, argon, helium, or nitrogen).

The lithium ion conductivity of the lithium ion conductor according to the embodiment of the present invention is not particularly limited; however, it is preferably 1.0×10⁻⁶ S/cm or more and more preferably 1.0×10⁻⁵ S/cm or more from the viewpoint of application to various use applications.

The lithium ion conductor according to the embodiment of the present invention contains the first lithium compound and the second lithium compound.

The mixing ratio of the first lithium compound and the second lithium compound in the lithium ion conductor is not particularly limited. However, the quantity ratio of content between the second lithium compound and the first lithium compound (the mass of the second lithium compound/the mass of the first lithium compound) is not particularly limited; however, it is preferably 1/20 to 1/1, more preferably 1/20 to 1/2, and still more preferably 1/16 to 1/3 from the viewpoint that the lithium ion conductivity of the lithium ion conductor is more excellent.

The lithium ion conductor according to the embodiment of the present invention preferably satisfies the following requirements 2 or 3 from the viewpoint that the lithium ion conductivity is more excellent.

The requirement 2: The Raman intensity of the lithium tetraborate in the lithium ion conductor at 1,800 cm¹ is 1.6 times or more with respect to a Raman intensity at 1,000 cm⁻¹ in a Raman spectrum.

The requirement 3: the coefficient of determination obtained by carrying out a linear regression analysis according to a least squares method in a wave number range of 600 to 850 cm⁻¹ of the second lithium compound (the lithium tetraborate) in the lithium ion conductor is 0.9000 or more in the Raman spectrum.

Hereinafter, the requirements 2 and 3 will be described in detail.

First, the requirement 2 will be described in detail.

In the requirement 2, first, the Raman spectra of the first lithium compound and the second lithium compound in the lithium ion conductor are acquired. Raman imaging is carried out as the measuring method for a Raman spectrum. The Raman imaging is a microscopic spectroscopy method that combines Raman spectroscopy with a microscopic technique. Specifically, it is a method of scanning a sample with excitation light to detect measurement light including Raman scattered light, and then visualizing the distribution or the like of components based on the intensity of the measurement light.

The measurement conditions for Raman imaging are as follows: an excitation light of 532 nm, an objective lens of 100 magnifications, a point scanning according to the mapping method, a step of 1 μm, an exposure time per point of 1 second, the number of times of integration of 1, and a measurement range of a range of 70 μm×50 μm.

In addition, the Raman spectrum data is subjected to a principal component analysis (PCA) processing to remove noise. Specifically, in the principal component analysis processing, the spectrum is recombined using components having an autocorrelation coefficient of 0.6 or more.

Next, the Raman intensities at 1,000 cm⁻¹ and 1,800 cm⁻¹ in the Raman spectra of the obtained first lithium compound and second lithium compound are read.

FIG. 8 is a graph showing an example of Raman spectra of a first lithium compound and a second lithium compound in a lithium ion conductor. The lower solid line in the figure is the Raman spectrum of the first lithium compound, and the upper solid line in the figure is the Raman spectrum of the second lithium compound.

As shown in FIG. 8, the Raman intensities at 1,000 cm⁻¹ and 1,800 cm⁻¹ in the Raman spectrum in which the vertical axis is the Raman intensity and the lateral axis is the Raman shift are read.

In the requirement 2, the Raman intensity at 1,800 cm⁻¹ in the Raman spectrum of the second lithium compound is 1.60 times or more with respect to the Raman intensity at 1,000 cm⁻¹. Among the above, the above ratio (the Raman intensity at 1,800 cm⁻¹/the Raman intensity at 1,000 cm⁻¹) is preferably 1.70 times or more from the viewpoint that the ion conductivity of the lithium ion conductor is more excellent. The upper limit thereof is not particularly limited; however, it is 2.50 times or less in a large number of cases.

Generally, in a Raman spectrum, in a case where a measurement component has fluorescence characteristics, the background slope of the Raman spectrum tends to be positively large. That is, as described above, the fact that “the Raman intensity at 1,800 cm⁻¹/the Raman intensity at 1,000 cm⁻¹” is large indicates that the second lithium compound has fluorescence characteristics. Such fluorescence characteristics are rarely observed in general lithium tetraborate crystals, and thus they are characteristics peculiar to the second lithium compound. Although the details of why the above-described fluorescence characteristics are obtained in the second lithium compound are unknown, it is presumed to be because the second lithium compound has a new excitation level due to the fact that the crystal structure is different from general lithium tetraborate crystals. As a result, a case where the second lithium compound has such fluorescent characteristics indicates that the second lithium compound is easily plastically deformed due to the crystal structure different from those in the related art, and the conductivity of the Li ion is excellent as well.

Next, the requirement 3 will be described in detail.

In the requirement 3, first, the Raman spectrum of the second lithium compound in the lithium ion conductor is acquired. The acquisition method for a Raman spectrum is the same as the acquisition method for a Raman spectrum in the requirement 2 described above.

Next, the coefficient of determination obtained by carrying out a linear regression analysis according to a least squares method in a wave number range of 600 to 850 cm⁻¹ is determined in a Raman spectrum of the obtained second lithium compound. The method of determining a coefficient of determination is the same as the method of determining a coefficient of determination in the requirement 4 described above.

In the requirement 3, the coefficient of determination (the coefficient of determination R²) is 0.9000 or more. Among the above, it is preferably 0.9300 or more from the viewpoint that the ionic conductivity of the lithium ion conductor is more excellent. The upper limit thereof is not particularly limited; however, it is, for example, 1.0000.

As described above, the fact that the coefficient of determination is equal to or more of a predetermined value indicates that the second lithium compound contains almost no crystal structures contained in a general lithium tetraborate crystal. For this reason, the second lithium compound is easily deformed and has excellent conductivity of Li⁺, and thus as a result, the ion conductivity of the lithium ion conductor is more excellent.

<Use Application>

The composite body and lithium ion conductor according to the embodiment of the present invention can be used in various use applications.

For example, it can be used in various batteries (for example, an all-solid state lithium ion secondary battery, a solid oxide-type fuel cell, and solid oxide water vapor electrolysis). Among them, the composite body and the lithium ion conductor according to the embodiment of the present invention are preferably used in an all-solid state lithium ion secondary battery.

More specifically, the composite body according to the embodiment of the present invention is preferably used in the formation of a solid electrolyte that is contained in a positive electrode active material layer, a solid electrolyte layer, and a negative electrode active material layer in an all-solid state lithium ion secondary battery. Further, the lithium ion conductor according to the embodiment of the present invention is preferably used as a solid electrolyte that is contained in a positive electrode active material layer, a solid electrolyte layer, and a negative electrode active material layer in an all-solid state lithium ion secondary battery.

<Composition for Forming Solid Electrolyte Layer>

The composite body according to the embodiment of the present invention is preferably used as a component of a composition for forming a solid electrolyte layer. That is, the composition for forming a solid electrolyte layer according to the embodiment of the present invention contains the above-described composite body.

The composite body contained in the composition for forming a solid electrolyte layer is as described above.

The composition for forming a solid electrolyte layer may contain components other than the composite body.

Examples of the other components include the binder and lithium salt described above.

The composition for forming a solid electrolyte layer may contain another solid electrolyte other than the composite body. The other solid electrolyte means a solid-form electrolyte capable of migrating ions therein. The solid electrolyte is preferably an inorganic solid electrolyte. The inorganic solid electrolyte is generally solid in a static state, and thus, generally, it is not disassociated or liberated into cations and anions.

Examples of the other solid electrolyte include a sulfide-based inorganic solid electrolyte, an oxide-based inorganic solid electrolyte, a halide-based inorganic solid electrolyte, and a hydride-based solid electrolyte.

Further, the composition for forming a solid electrolyte layer may contain a dispersion medium.

Examples of the dispersion medium include various organic solvents. Examples of the organic solvent include an alcohol compound, an ether compound, an amide compound, an amine compound, a ketone compound, an aromatic compound, an aliphatic compound, a nitrile compound, and an ester compound. Among them, an ether compound, a ketone compound, an aromatic compound, an aliphatic compound, or an ester compound is preferable.

The dispersion medium preferably has a boiling point of 50° C. or higher and more preferably 70° C. or higher at normal pressure (1 atm). The upper limit thereof is preferably 250° C. or lower and more preferably 220° C. or lower.

One kind of the dispersion medium may be used singly, or two or more kinds thereof may be used in combination.

The content of the dispersion medium in the composition for forming a solid electrolyte layer is not particularly limited. However, with respect to the total mass of the composition for forming a solid electrolyte layer, it is preferably 1% by mass or more, more preferably 20% by mass or more, still more preferably 25% by mas or more, and particularly preferably 30% by mass or more, and it is preferably 99% by mass or less, more preferably 80% by mass or less, still more preferably 75% by mass or less, and particularly preferably 70% by mass or less.

The method of forming a solid electrolyte layer using the above-described composition for forming a solid electrolyte layer is not particularly limited; however, examples thereof include a method of applying a composition for forming a solid electrolyte layer and subjecting the formed coating film to a pressurization treatment.

The coating method for a composition for forming a solid electrolyte layer is not particularly limited, and examples thereof include spray coating, spin coating, dip coating, slit coating, stripe coating, an aerosol deposition method, thermal spraying, and bar coating.

It is noted that after applying the composition for forming a solid electrolyte layer, the obtained coating film may be subjected to a drying treatment, as necessary. The drying temperature is not particularly limited; however, the lower limit thereof is preferably 30° C. or higher, more preferably 60° C. or higher, and still more preferably 80° C. or higher. The upper limit of the drying temperature is preferably 300° C. or lower and more preferably 250° C. or lower.

The method of subjecting a coating film to a pressurization treatment is not particularly limited; however, examples thereof include a method using a known press device (for example, a hydraulic cylinder pressing machine).

The pressurizing force at the time of the pressurization treatment is not particularly limited; however, it is preferably 5 to 1,500 MPa and more preferably 300 to 600 MPa from the viewpoint that the lithium ion conductor of the solid electrolyte layer to be formed is more excellent.

The time of the pressurization treatment is not particularly limited; however, it is preferably 1 to 6 hours and more preferably 1 to 20 minutes from the viewpoint that the lithium ion conductor of the solid electrolyte layer to be formed is more excellent and the viewpoint of productivity.

Further, a heating treatment may be carried out at the time of the pressurization treatment. The heating temperature at the time of the heating treatment is not particularly limited; however, it is preferably 30 to 300° C., and the heating time is more preferably 1 minute to 6 hours.

The atmosphere during the pressurization is not particularly limited, and examples thereof include an atmosphere of atmospheric air, an atmosphere of dried air (the dew point: −20° C. or lower), and an atmosphere of inert gas (for example, argon, helium, or nitrogen).

<Composition for Forming Electrode>

The composite body according to the embodiment of the present invention is preferably used as a component of a composition for forming an electrode. That is, the composition for forming an electrode according to the embodiment of the present invention contains the above-described composite body.

The composition for forming an electrode according to the embodiment of the present invention contains the above-described composite body and an active material.

The mixing ratio of the composite body and the active material in the composition for forming an electrode is not particularly limited. However, the quantity ratio of content between the composite body and the active material (the mass of the composite body/the mass of the active material) is not particularly limited; however, it is preferably 0.01 to 50 and more preferably 0.05 to 20.

The composite body contained in the composition for forming an electrode is as described above.

Examples of the active material include a positive electrode active material and a negative electrode active material. Hereinafter, the active material will be described in detail.

(Negative Electrode Active Material)

The negative electrode active material is preferably capable of reversibly intercalating and deintercalating lithium ions. The negative electrode active material is not particularly limited, and examples thereof include a carbonaceous material, an oxide of a metal or metalloid element, a lithium single body, a lithium alloy, and a negative electrode active material capable of being alloyed with lithium.

The carbonaceous material that is used as the negative electrode active material is a material substantially consisting of carbon. Examples thereof include petroleum pitch, carbon black such as acetylene black (AB), graphite (natural graphite or artificial graphite such as vapor-grown graphite), and carbonaceous material obtained by baking a variety of synthetic resins such as polyacrylonitrile (PAN)-based resins or furfuryl alcohol resins.

Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree.

In addition, it is preferable that the carbonaceous material has the lattice spacing, density, or crystallite size described in JP1987-022066A (JP-S62-022066A), JP1990-006856A (JP-H2-006856A), and JP1991-045473A (JP-H3-045473A). The carbonaceous material is not necessarily a single material and, for example, may be a mixture of natural graphite and artificial graphite described in JP1993-090844A (JP-H5-090844A) or graphite having a coating layer described in JP1994-004516A (JP-H6-004516A).

The carbonaceous material is preferably hard carbon or graphite, and it is more preferably graphite.

The oxide of a metal element or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element, and an oxide of a metalloid element (a metalloid oxide). It is noted that a composite oxide of a metal element and a composite oxide of a metal element and a metalloid element are also collectively referred to as “metal composite oxide).

These oxides are preferably noncrystalline oxides, and they are also preferably chalcogenides which are reaction products between metal elements and elements in Group 16 of the periodic table.

In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine.

In addition, “amorphous” represents an oxide having a broad scattering band with an apex in a range of 200 to 400 in terms of 2θ value in case of being measured by an X-ray diffraction method using CuKα rays, and the oxide may have a crystalline diffraction line. The highest intensity in a crystalline diffraction line observed in a range of 40° to 70° in terms of 2θ value is preferably 100 times or less and more preferably 5 times or less with respect to the intensity of a diffraction line at the apex in a broad scattering band observed in a range of 20° to 400 in terms of 2θ value, and it is still more preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are still more preferable.

The noncrystalline oxide and the chalcogenide are preferably Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, or Sb₂S₅.

The negative electrode active material which can be used in combination with noncrystalline oxide negative electrode active material containing Sn, Si, or Ge as a major constitutional component is preferably a carbonaceous material capable of intercalating and/or deintercalating lithium ions or lithium metal, a lithium single body, a lithium alloy, or a negative electrode active material that is capable of being alloyed with lithium.

It is preferable that an oxide of a metal element or a metalloid element (in particular, a metal (composite) oxide) and the chalcogenide contains at least one of titanium or lithium as the constitutional component from the viewpoint of high current density charging and discharging characteristics.

Examples of the metal composite oxide (lithium composite metal oxide) including lithium include a composite oxide of lithium oxide and the above metal composite oxide or the above chalcogenide. More specific examples thereof include Li₂SnO₂.

It is also preferable that the negative electrode active material (for example, a metal oxide) contains a titanium element (a titanium oxide). Specifically, Li₄Ti₅O₁₂ (lithium titanium oxide [LTO]) is preferable from the viewpoint that the volume variation during the intercalation and deintercalation of lithium ions is small, and thus the high-speed charging and discharging characteristics are excellent, and the deterioration of electrodes is suppressed, whereby it becomes possible to improve the life of the all-solid state lithium ion secondary battery.

The lithium alloy as the negative electrode active material is not particularly limited as long as it is typically used as a negative electrode active material for an all-solid state lithium ion secondary battery, and examples thereof include a lithium aluminum alloy.

The negative electrode active material capable of being alloyed with lithium is not particularly limited as long as it is typically used as a negative electrode active material for an all-solid state lithium ion secondary battery. Examples of the negative electrode active material include a negative electrode active material (an alloy) containing a silicon element or a tin element and a metal such as Al or In, where a negative electrode active material (a silicon-containing active material) containing a silicon element capable of exhibiting high battery capacity is preferable, and a silicon-containing active material in which the content of the silicon element is 50% by mole or more with respect to all constitutional elements is more preferable.

In general, a negative electrode containing the negative electrode active material (for example, an Si negative electrode containing a silicon-containing active material or an Sn negative electrode containing an active material containing a tin element) can intercalate a larger amount of Li ions than a carbon negative electrode (for example, graphite or acetylene black). That is, the amount of Li ions intercalated per unit mass increases. Therefore, it is possible to increase the battery capacity. As a result, there is an advantage that the battery driving duration can be extended.

Examples of the silicon-containing active material include a silicon-containing alloy (for example, LaSi₂, VSi₂, La—Si, Gd—Si, or Ni—Si) containing a silicon material such as Si or SiOx (0<x≤1) and furthermore titanium, vanadium, chromium, manganese, nickel, copper, or lanthanum, or a structured active material thereof (for example, LaSi₂/Si). Other examples thereof include an active material containing a silicon element and a tin element, such as SnSiO₃ or SnSiS₃. In addition, since SiOx itself can be used as a negative electrode active material (a metalloid oxide) and Si is produced along with the operation of an all-solid state lithium ion secondary battery, SiOx can be used as a negative electrode active material (or a precursor material thereof) capable of being alloyed with lithium.

Examples of the negative electrode active material having a tin element include an active material containing Sn, SnO, SnO₂, SnS, or SnS₂, and the above-described active material including a silicon element and a tin element.

From the viewpoint of battery capacity, the negative electrode active material is preferably a negative electrode active material capable of being alloyed with lithium, more preferably the above-described silicon material or silicon-containing alloy (an alloy containing a silicon element), and still more preferably silicon (Si) or a silicon-containing alloy.

The shape of the negative electrode active material is not particularly limited; however, it is preferably a particle shape. The volume average particle diameter of the negative electrode active material is not particularly limited; however, it is preferably 0.1 to 60 μm, more preferably 0.5 to 20 μm, and still more preferably 1.0 to 15 μm.

The volume average particle diameter is measured according to the following procedure.

Using water (heptane in a case where the inorganic solid electrolyte is unstable in water), the negative electrode active material is diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer, and a quartz cell for measurement at a temperature of 25° C. to obtain the volume average particle diameter. Other detailed conditions and the like can be found in JIS Z8828: 2013 “Particle Diameter Analysis-Dynamic Light Scattering” as necessary. Five samples per level are produced and measured, and the average values thereof are employed.

One kind of negative electrode active material may be used singly, or two or more kinds thereof may be used in combination.

The surface of the negative electrode active material may be subjected to surface coating with another metal oxide.

Examples of the surface coating agent include a metal oxide containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the negative electrode active material may be subjected to a surface treatment with sulfur or phosphorous.

Further, the particle surface of the negative electrode active material may be subjected to a surface treatment with an actinic ray or an active gas (for example, plasma) before or after the surface coating.

(Positive Electrode Active Material)

The positive electrode active material is preferably capable of reversibly intercalating and/or deintercalating lithium ions. The positive electrode active material is not particularly limited. It is preferably a transition metal oxide and more preferably a transition metal oxide having a transition metal element M^{a} (one or more elements selected from Co, Ni, Fe, Mn, Cu, and V). In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The amount of the element to be mixed is preferably 0% to 30% by mol of the amount (100% by mol) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME). Among them, a transition metal oxide having a bedded salt-type structure (MA) is preferable, and LiCoO₂ or LiNi_{1/3}Co_{1/3}Mn_{1/3}O₂ is more preferable.

Examples of the transition metal oxides having a bedded salt-type structure (MA) include LiCoO₂ (lithium cobalt oxide [LCO]), LiNi₂O₂(lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂(lithium manganese nickelate).

Examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON-type vanadium phosphate salt such as Li₃V₂(PO₄)₃(lithium vanadium phosphate).

Examples of the lithium-containing transition metal halogenated phosphoric acid compound (MD) include an iron fluorophosphate such as Li₂FePO₄F, a manganese fluorophosphate such as Li₂MnPO₄F, a cobalt fluorophosphate such as Li₂CoPO₄F.

Examples of the lithium-containing transition metal silicate compound (ME) include Li₂FeSiO₄, Li₂MnSiO₄, and Li₂CoSiO₄.

The shape of the positive electrode active material is not particularly limited; however, it is preferably a particle shape. The volume average particle diameter of the positive electrode active material is not particularly limited; however, it is preferably 0.1 to 50 μm.

The volume average particle diameter of the positive electrode active material particles can be measured in the same manner as the volume average particle diameter of the negative electrode active material.

A positive electrode active material obtained using a baking method may be used after being washed with water, an acidic aqueous solution, an alkaline aqueous solution, or an organic solvent.

Similar to the negative electrode active material, the positive electrode active material may be subjected to surface coating with the above-described surface coating agent, sulfur, or phosphorus, and further with an actinic ray.

One kind of positive electrode active material may be used singly, or two or more kinds thereof may be used in combination.

The composition for forming an electrode may contain other components other than the composite body and the active material.

The composition for forming an electrode may contain a conductive auxiliary agent.

As the conductive auxiliary agent, a conductive auxiliary agent that is known as a general conductive auxiliary agent can be used. Examples of the conductive auxiliary agent include graphite such as natural graphite and artificial graphite, carbon black such as acetylene black, Ketjen black, and furnace black, amorphous carbon such as needle cokes, a carbon fiber such as a vapor-grown carbon fiber or a carbon nanotube, and a carbonaceous material such as graphene or fullerene, which are electron-conductive materials. Further, a conductive polymer such as polyaniline, polypyrrole, polythiophene, polyacetylene, or a polyphenylene derivative may also be used.

In addition to the above conductive auxiliary agent, a general conductive auxiliary agent containing no carbon atom such as a metal powder or metal fiber may be used.

It is noted that the conductive auxiliary agent refers to those that do not cause the intercalation and deintercalation of Li at a time when a battery is charged and discharged and do not function as an active material. As a result, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

In addition, examples of the other components also include the above-described binder and lithium salt.

The composition for forming an electrode may contain a dispersion medium. The kind and preferred aspect of dispersion medium are the same as the kind and preferred aspect of the dispersion medium which may be contained in the above-described composition for forming a solid electrolyte layer.

The composition for forming an electrode may contain, as other components other than the respective components described above, an ionic liquid, a thickener, a crosslinking agent (an agent that causes a crosslinking reaction by radical polymerization, condensation polymerization, or ring-opening polymerization), a polymerization initiator (an agent that generates an acid or a radical by heat or light), an antifoaming agent, a leveling agent, a dehydrating agent, and an antioxidant.

The method of forming electrodes (a negative electrode active material layer and a positive electrode active material layer) using the above-described composition for forming an electrode is not particularly limited; however, examples thereof include a method of applying a composition for forming an electrode and subjecting the formed coating film to a pressurization treatment.

The coating method for a composition for forming an electrode is not particularly limited, and examples thereof include spray coating, spin coating, dip coating, slit coating, stripe coating, an aerosol deposition method, thermal spraying, and bar coating.

It is noted that after applying the composition for forming an electrode, the obtained coating film may be subjected to a drying treatment, as necessary. The drying temperature is not particularly limited; however, the lower limit thereof is preferably 30° C. or higher, more preferably 60° C. or higher, and still more preferably 80° C. or higher. The upper limit of the drying temperature is preferably 300° C. or lower and more preferably 250° C. or lower.

The method of subjecting a coating film to a pressurization treatment is not particularly limited; however, examples thereof include a method using a known press device (for example, a hydraulic cylinder pressing machine).

The pressurizing force at the time of the pressurization treatment is not particularly limited; however, it is preferably 5 to 1,500 MPa and more preferably 300 to 600 MPa.

The time of the pressurization treatment is not particularly limited; however, it is preferably 1 minute to 6 hours and more preferably 1 to 20 minute from the viewpoint of productivity.

Further, a heating treatment may be carried out at the time of the pressurization treatment. The heating temperature at the time of the heating treatment is not particularly limited; however, it is preferably 30 to 300° C., and the heating time is preferably 1 minute to 6 hours.

The atmosphere during the pressurization is not particularly limited, and examples thereof include an atmosphere of atmospheric air, an atmosphere of dried air (the dew point: −20° C. or lower), and an atmosphere of inert gas (for example, argon, helium, or nitrogen).

<Electrode Sheet for all-Solid State Lithium Ion Secondary Battery>

The lithium ion conductor according to the embodiment of the present invention may be contained in an electrode sheet for an all-solid state lithium ion secondary battery.

The electrode sheet for an all-solid state lithium ion secondary battery according to the embodiment of the present invention is a sheet-shaped molded body capable of forming an electrode active material layer of an all-solid state lithium ion secondary battery, and it is preferably used in an electrode or a laminate of an electrode and a solid electrolyte layer.

It suffices that an electrode sheet for an all-solid state lithium ion secondary battery according to the embodiment of the present invention (simply, also referred to as an “electrode sheet”) is an electrode sheet including an active material electrode layer (hereinafter, simply also referred to as an “active material electrode layer”) selected from the group consisting of a negative electrode active material layer and a positive electrode active material layer, and it may be a sheet in which an active material electrode layer is formed on a base material (a collector) or may be a sheet that is formed of an active material electrode layer without containing a substrate. The electrode sheet is typically a sheet including a collector and an active material electrode layer, and examples of the aspect thereof include an aspect including a collector, an active material electrode layer, and a solid electrolyte layer in this order and an aspect including a collector, an active material electrode layer, a solid electrolyte layer, and an active material electrode layer in this order.

The electrode sheet according to the embodiment of the present invention may include the above-described other layer. The thickness of each of the layers forming the electrode sheet according to the embodiment of the present invention is the same as the layer thickness of each of the layers described below regarding the all-solid state lithium ion secondary battery.

In the sheet for an all-solid state lithium ion secondary battery according to the embodiment of the present invention, at least one layer of the active material electrode layers contains the lithium ion conductor according to the embodiment of the present invention.

A manufacturing method for an electrode sheet for an all-solid state lithium ion secondary battery according to the embodiment of the present invention is not particularly limited. For example, the electrode sheet for an all-solid state secondary battery according to the embodiment of the present invention can be manufactured by forming the active material electrode layer using the composition for forming an electrode according to the embodiment of the present invention.

Examples thereof include a method of applying a composition for forming an electrode onto a collector (another layer may be interposed) to form a coating film and subjecting the resultant coating film to a pressurization treatment.

Examples of the method of applying a composition for forming an electrode and the method of subjecting a coating film to a pressurization treatment include the methods described in the composition for forming an electrode.

<All-Solid State Lithium Ion Secondary Battery>

The all-solid state lithium ion secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The positive electrode active material layer is preferably formed on a positive electrode collector to configure a positive electrode. The negative electrode active material layer is preferably formed on a negative electrode collector to configure a negative electrode.

At least one layer of the negative electrode active material layer, the positive electrode active material layer, or the solid electrolyte layer contains the lithium ion conductor according to the embodiment of the present invention.

The thickness of each of the negative electrode active material layer, the solid electrolyte layer, and the positive electrode active material layer is not particularly limited. In case of taking a dimension of a general all-solid state lithium ion secondary battery into account, the thickness of each of the layers is preferably 10 to 1,000 μm and more preferably 20 μm or more and less than 500 μm.

The thickness of at least one of the positive electrode active material layer or the negative electrode active material layer is still more preferably 50 μm or more and less than 500 μm.

Each of the positive electrode active material layer and the negative electrode active material layer may include a collector on the side opposite to the solid electrolyte layer.

Depending on the use application, the all-solid state lithium ion secondary battery according to the embodiment of the present invention may be used as the all-solid state lithium ion secondary battery having the above-described structure as it is but is preferably sealed in an appropriate housing to be used in the form of a dry cell. The housing may be made of a metal or may be made of a resin (plastic). Examples of the housing made of a metal include a housing of an aluminum alloy and a housing made of stainless steel. It is preferable that the housing made of a metal is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

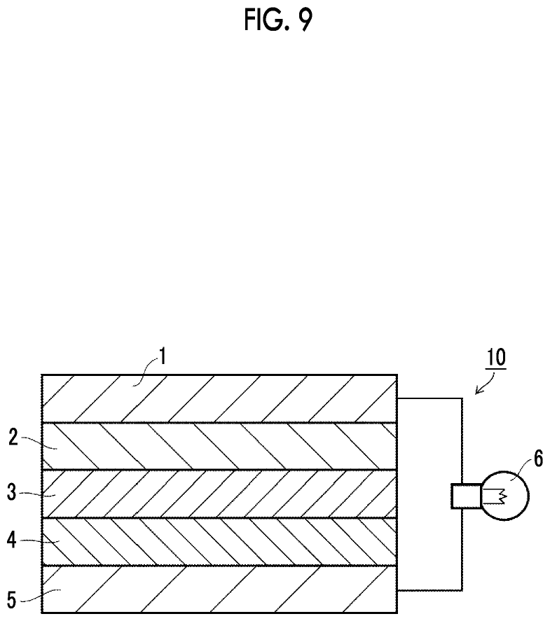

Hereinafter, the all-solid state lithium ion secondary battery of the preferred embodiments of the present invention will be described with reference to FIG. 9; however, the present invention is not limited thereto.

FIG. 9 is a cross-sectional view schematically illustrating an all-solid state lithium ion secondary battery according to a preferred embodiment of the present invention. In the case of being seen from the negative electrode side, an all-solid state lithium ion secondary battery 10 of the present embodiment includes a negative electrode collector 1, a negative electrode active material layer 2, a solid electrolyte layer 3, a positive electrode active material layer 4, and a positive electrode collector 5 in this order.

At least one layer of the negative electrode active material layer 2, the positive electrode active material layer 4, or the solid electrolyte layer 3 contains the lithium ion conductor according to the embodiment of the present invention.

The respective layers are in contact with each other, and thus structures thereof are adjacent. In a case in which the above-described structure is employed, during charging, electrons (e) are supplied to the negative electrode side, and lithium ions (Li⁺) are accumulated on the negative electrode side. On the other hand, during discharging, the lithium ions (Li⁺) accumulated in the negative electrode side return to the positive electrode, and electrons are supplied to an operation portion 6. In an example illustrated in the drawing, an electric bulb is employed as a model at the operation portion 6 and is lit by discharging.

The negative electrode active material layer 2 contains the above-described negative electrode active material.

The positive electrode active material layer 4 contains the above-described positive electrode active material.

The positive electrode collector 5 and the negative electrode collector 1 are preferably an electron conductor.

Examples of the material that forms the positive electrode collector include aluminum, an aluminum alloy, stainless steel, nickel, and titanium, where aluminum or an aluminum alloy is preferable. It is noted that examples of the positive electrode collector include a collector (a collector on which a thin film has been formed) obtained by subjecting the surface of aluminum or stainless steel to a treatment with carbon, nickel, titanium, or silver.

Examples of the material that forms the negative electrode collector include aluminum, copper, a copper alloy, stainless steel, nickel, and titanium, where aluminum, copper, a copper alloy, or stainless steel is preferable. It is noted that examples of the negative electrode collector include a collector obtained by subjecting the surface of aluminum, copper, copper alloy, or stainless steel to a treatment with carbon, nickel, titanium, or silver.

The shape of the collector is generally a film sheet shape; however, another shape may be used.

The thickness of the collector is not particularly limited; however, it is preferably 1 to 500 μm.

In addition, protrusions and recesses are preferably provided on the surface of the collector by carrying out a surface treatment.

The manufacturing method for the all-solid state lithium ion secondary battery described above is not particularly limited, and examples thereof include known methods. Among them, a method using the above-described composition for forming an electrode and/or composition for forming a solid electrolyte layer is preferable.

For example, a composition for forming a positive electrode, which contains a positive electrode active material, is applied onto a metal foil which is a positive electrode collector to form a positive electrode active material layer, a composition for forming a solid electrolyte layer is subsequently applied onto this positive electrode active material layer to form a solid electrolyte layer, a composition for forming a negative electrode, which contains a negative electrode active material, is further applied onto the solid electrolyte layer to form a negative electrode active material layer, and a negative electrode collector (a metal foil) is overlaid on the negative electrode active material layer to subject the obtained laminate to a pressurization treatment, whereby it is possible to obtain an all-solid state lithium ion secondary battery having a structure in which the solid electrolyte layer is sandwiched between the positive electrode active material layer and the negative electrode active material layer. A desired all-solid state lithium ion secondary battery can also be manufactured by enclosing the all-solid state secondary battery in a housing.

In addition, it is also possible to manufacture an all-solid state lithium ion secondary battery by carrying out the forming method for each layer in reverse order to form a negative electrode active material layer, a solid electrolyte layer, and a positive electrode active material layer on a negative electrode collector and overlaying a positive electrode collector thereon.

Alternatively, as another method, a positive electrode active material layer, a solid electrolyte layer, and a negative electrode active material layer may be separately produced and laminated to produce an all-solid state lithium ion secondary battery.

The all-solid state lithium ion secondary battery is preferably initialized after production or before use. The initialization is not particularly limited, and it is possible to initialize an all-solid state lithium ion secondary battery by, for example, carrying out initial charging and discharging in a state where the pressing pressure is increased and then releasing the pressure up to a pressure at which the all-solid state secondary battery is ordinarily used.

<Use Application of all-Solid State Lithium Ion Secondary Battery>

The all-solid state lithium ion secondary battery according to the embodiment of the present invention can be applied to a variety of use applications. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of the consumer usage thereof include an automobile, an electric vehicle, a motor, a lighting instrument, a toy, a game device, a road conditioner, a watch, a strobe, a camera, and a medical device (a pacemaker, a hearing aid, a shoulder massage device, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto to be interpreted. “Parts” and “%” that represent compositions in the following Examples are mass-based unless particularly otherwise described.

<Preparation of First Lithium Compound>

A LiLaZr oxide (hereinafter: LLZO) having a garnet-type structure containing Li—La—Zr—O, as the first lithium compound, was synthesized according to a solid phase method by using, as raw materials, Li₂CO₃ (99.9%, manufactured by RARE METALLIC Co., Ltd.), La₂O₃ (96.68%, manufactured by FUJIFILM Wako Pure Chemical Corporation), and ZrO₂ (99.9%, manufactured by Shuzui Co., Ltd.).

Specifically, the raw material powder was mixed in a mortar, placed on an alumina plate, covered with an alumina crucible, and baked in the atmospheric air at 850° C. for 12 hours to synthesize a preliminarily baked powder. A compacted powder pellet was produced using the synthesized preliminarily baked powder. The obtained compacted powder pellet was covered with the preliminarily baked powder and subjected to main baking in the atmospheric air at 1,100° C. to 1,230° C. for 6 hours to obtain a first lithium compound.

The lithium ion conductivity of the obtained first lithium compound was 3.7×10⁻⁴ S/cm at 25° C. Regarding the lithium ion conductivity, it is noted that Au electrodes were installed on the front surface and the back surface of the obtained pellet of the first lithium compound according to a vapor deposition method, and the lithium ion conductivity was estimated from the analysis of the arc diameter of the Cole-Cole plot (the Nyquist plot) obtained by measuring the alternating current impedance (measurement temperature:25° C., applying voltage: 100 mV, and measurement frequency range: 1 Hz to 1 MHz) with the two Au electrodes being interposed.

Further, as a result of analyzing the composition of the obtained first lithium compound according to the neutron diffraction method and the Rietveld method, it was confirmed that it is Li_{5.95}Al_{0.35}La₃Zr₂O₁₂.

In addition, the particle size distribution of the obtained first lithium compound was about several μm to 10 μm, and the median diameter (D50) was 3.1 μm. It is noted that the particle size distribution of the first lithium compound was determined according to the above-described image analysis method and was used as an input value for fitting at the time of obtaining the bulk elastic modulus described later.

In addition, the bulk elastic modulus of the obtained first lithium compound was 105 GPa.

The bulk elastic modulus was calculated according to the following method.

First, the first lithium compound was suspended in pure water (concentration: 1.2% by mass), the ultrasonic attenuation spectrum of the suspension was measured, and the bulk elastic modulus of the particle was determined from the fitting according to the scattering attenuation theoretical expression. The fitting was carried out by setting the density of the first lithium compound to 4.97 g/ml and the Poisson's ratio to 0.257. An ultrasonic attenuation spectrum that monotonically increases at 10 to 70 MHz was obtained from the first lithium compound. The actually measured ultrasonic attenuation spectrum could be well fitted according to the scattering attenuation theory with the particle size distribution (approximated by the Schultz distribution with an average of 4.7 μm), the particle density, and the Poisson's ratio as the input values.

<Preparation of Second Lithium Compound>

Using a ball mill (P-7 manufactured by FRITSCH), a Li₂B₄O₇ (LBO) powder (manufactured by RARE METALLIC Co., Ltd.) was subjected to ball milling to obtain a second lithium compound under the following conditions, pot: YSZ (45 ml), pulverization ball: YSZ (average particle diameter: 5 mm, number of balls: 50 balls), rotation speed: 500 revolutions per minute (rpm), LBO powder amount: 2 g, atmosphere: atmospheric air, and treatment time of ball milling: 100 hours.

The particle size distribution of the obtained second lithium compound was about several μm to 10 μm, and the median diameter (D50) was 1.5 μm.

In addition, the bulk elastic modulus of the obtained second lithium compound was 36 GPa. It is noted that the bulk elastic modulus of the raw material LBO powder before the ball milling treatment was 47 GPa.

The methods of calculating the median diameter and the bulk elastic modulus were the same as the methods of calculating the median diameter and the bulk elastic modulus of the first lithium compound. It is noted that at the time of calculating a bulk elastic modulus, the fitting was carried out by setting the density of the second lithium compound to 2.3 g/ml and the Poisson's ratio to 0.12.

Using the obtained second lithium compound, the X-ray total scattering measurement is carried out with SPring-8 BL04B2 (acceleration voltage: 61.4 keV, wavelength: 0.2019 Å). A sample was sealed in a Capton capillary of 2 mmφ or 1 mmφ, and the experiment was carried out under a vacuum. It is noted that the obtained data were subjected to Fourier transform as described above to obtain a reduced two-body distribution function.

As a result of the analysis, in a reduced two-body distribution function G(r) obtained from an X-ray total scattering measurement of the lithium tetraborate, in a range where r is 1 to 5 Å, the first peak in which G(r) of a peak top indicates 1.0 or more and the peak top is located at 1.43 Å, and the second peak in which G(r) of a peak top indicates 1.0 or more and the peak top is located at 2.40 Å were confirmed, and it was confirmed that the absolute value of G(r) in a range where r is more than 5 Å and 10 Å or less is less than 1.0 (see FIG. 1).

From the result of FIG. 1 above, it was found that the second lithium compound has almost no long-range order, and it was confirmed that it is amorphous. On the other hand, in the second lithium compound, the peaks attributed to the interatomic distance of B-O and the interatomic distance of B-B, which are observed in the general lithium tetraborate crystal, are maintained. A general lithium tetraborate crystal has a structure (a diborate structure) in which a BO₃ tetrahedron and a BO₂ triangle are present at a ratio of 1:1, and it is presumed that this structure is maintained in the second lithium compound.

In addition, a spectrum of the powder X-ray diffraction of the second lithium compound was acquired, from which it was confirmed that the second lithium compound has no crystalline diffraction line in a range of 20 to 250 in terms of 2θ value.

A proportion of a full width at half maximum (a full width at half maximum 2) of a peak in which a chemical shift appears in a range of −100 to +100 ppm in a spectrum obtained in a case where a solid ⁷Li-NMR measurement of the second lithium compound is carried out at 120° C. with respect to a full width at half maximum (a full width at half maximum 1) of a peak in which a chemical shift appears in a range of −100 to +100 ppm in a spectrum obtained in a case where the solid ⁷Li-NMR measurement of the obtained second lithium compound is carried out at 20° C., {(the full width at half maximum 2/the full width at half maximum 1)×100}, was 46%.

In the Raman spectrum of the obtained second lithium compound, the coefficient of determination obtained by carrying out a linear regression analysis according to a least squares method in a wave number range of 600 to 850 cm⁻¹ was 0.9677.

(LBO Powder for Comparative Example)

As the LBO powder for the comparative example described later, a (LBO) powder (manufactured by RARE METALLIC Co., Ltd.) not subjected to the ball milling treatment was used.

As a result of carrying out an X-ray total scattering measurement in the same manner as in the above second lithium compound, by using the LBO powder for the comparative example, a plurality of peaks of which G(r) of a peak top is 1.0 or more are present in a range where r is more than 5 Å and 10 Å or less in the reduced two-body distribution function G(r), and the requirement 1 was not satisfied.

In addition, a proportion of a full width at half maximum (a full width at half maximum 2) of a peak in which a chemical shift appears in a range of −100 to +100 ppm in a spectrum obtained in a case where a solid ⁷Li-NMR measurement of the LBO powder for the comparative example is carried out at 120° C. with respect to a full width at half maximum (a full width at half maximum 1) of a peak in which a chemical shift appears in a range of −100 to +100 ppm in a spectrum obtained in a case where the solid ⁷Li-NMR measurement of the LBO powder for the comparative example is carried out at 20° C., {(the full width at half maximum 2/the full width at half maximum 1)×100}, was 99.6%.

In the Raman spectrum of the LBO powder for the comparative example, the coefficient of determination obtained by carrying out a linear regression analysis according to a least squares method in a wave number range of 600 to 850 cm⁻¹ was 0.1660.

### Example 1

The first lithium compound and the second lithium compound, obtained as described above, were mixed at a mixing mass ratio of 8:1 (the mass of the first lithium compound: the mass of the second lithium compound) to obtain a composite body.

Next, the obtained composite body was subjected to powder compaction molding at 25° C. (room temperature) at an effective pressure of 100 MPa to obtain a compacted powder body (a lithium ion conductor).

The lithium ion conductivity of the obtained compacted powder body was 1.3×10⁻⁶ S/cm.

By observing the obtained compacted powder body with a scanning electron microscope (observation acceleration voltage: 3 kV, EDX: 30 kV), it was revealed that the intimate attachment at the interface of the first lithium compound/the second lithium compound is good.

### Example 2

A compacted powder body (a lithium ion conductor) was obtained according to the same procedure as in Example 1 except that the mixing mass ratio of the first lithium compound and the second lithium compound (the mass of the first lithium compound:the mass of the second lithium compound) was changed from 8:1 to 4:1.

The lithium ion conductivity of the obtained compacted powder body was 1.2×10⁻⁵ S/cm.

### Example 3

A compacted powder body (a lithium ion conductor) was obtained according to the same procedure as in Example 1 except that the mixing mass ratio of the first lithium compound and the second lithium compound (the mass of the first lithium compound:the mass of the second lithium compound) was changed from 8:1 to 2:1.

The lithium ion conductivity of the obtained compacted powder body was 4.3×10⁻⁶ S/cm.

### Example 4

A compacted powder body (a lithium ion conductor) was obtained according to the same procedure as in Example 1 except that the mixing mass ratio of the first lithium compound and the second lithium compound (the mass of the first lithium compound:the mass of the second lithium compound) was changed from 8:1 to 1:1.

The lithium ion conductivity of the obtained compacted powder body was 3.0×10⁻⁶ S/cm.

### Comparative Example 1

A compacted powder body (a lithium ion conductor) was obtained according to the same procedure as in Example 2 except that the LBO powder for the comparative example was used instead of the second lithium compound.

The lithium ion conductivity of the obtained compacted powder body was 10-8 S/cm.

By observing the obtained compacted powder body with a scanning electron microscope (observation acceleration voltage: 3 kV, EDX: 30 kV), it was revealed that a void at the interface of the first lithium compound/the LBO powder for the comparative example is present.

<Evaluation>

(Raman Spectrum)

The compacted powder bodies obtained in Examples 1 to 4 and Comparative Example 1 were subjected to Raman spectrum measurements.

In the compacted powder bodies of Examples 1 to 4, Raman bands characteristic of the LBO crystal (particularly strong bands present in a range of 716 to 726 cm⁻¹, 771 to 785 cm⁻¹, and 1,024 to 1,034 cm⁻¹) were hardly confirmed, whereas in the compacted powder body of Comparative Example 1, a Raman band characteristic of the LBO crystal was confirmed.

Next, the compacted powder bodies obtained in Examples 1 to 4 and Comparative Example 1 were subjected to Raman imaging measurements. The measurement conditions were as follows: an excitation light of 532 nm, an objective lens of 100 magnifications, a point scanning according to the mapping method, a step of 1 μm, an exposure time per point of 1 second, the number of times of integration of 1, and a measurement range of a range of 70 μm×50 μm. The noise was removed from the obtained data by PCA processing.

According to the above procedure, a region derived from the first lithium compound and a region derived from the second lithium compound in the compacted powder bodies of Examples 1 to 4 were identified. In addition, a region derived from the first lithium compound in Comparative Example 1 and a region derived from the LBO powder for the comparative example were identified.

Next, a ratio of the Raman intensity at 1,800 cm⁻¹ to the Raman intensity at 1,000 cm⁻¹ in the Raman spectrum of the second lithium compound in each of the compacted powder bodies of Examples 1 to 4 (the intensity at 1,800 cm⁻¹/the intensity at 1,000 cm⁻¹) were determined. The results are summarized in Table 1.

In addition, the coefficient of determination obtained by carrying out a linear regression analysis according to a least squares method in a wave number range of 600 to 850 cm⁻¹ is determined in a Raman spectrum of the second lithium compound in each of the compacted powder bodies of Examples 1 to 4. For the compacted powder body of Comparative Example 1, the coefficient of determination in the predetermined wave number range was determined by using the Raman spectrum of the LBO powder for the comparative example. The results are summarized in Table 1.

In the column of “Requirement 1” in Table 1, a case where the above-described requirement 1 is satisfied is denoted as “A”, and a case where the above-described requirement 1 is not satisfied is denoted as “B”.

In Table 1, the column of “Proportion of full width at half maximum (%)” indicates a proportion of a full width at half maximum of a peak in which a chemical shift appears in a range of −100 to +100 ppm in a spectrum obtained in a case where a solid ⁷Li-NMR measurement of the second lithium compound (or the LBO powder for the comparative example) is carried out at 120° C. with respect to a full width at half maximum of a peak in which a chemical shift appears in a range of −100 to +100 ppm in a spectrum obtained in a case where the solid ⁷Li-NMR measurement of the second lithium compound (or the LBO powder for the comparative example) is carried out at 20° C.

In Table 1, the column of “Coefficient of determination” of “Second lithium compound” and “LBO powder for comparative example” indicates a coefficient of determination obtained by carrying out a linear regression analysis according to a least squares method in a wave number range of 600 to 850 cm⁻¹ of the second lithium compound (or the LBO powder for the comparative example) in the Raman spectrum.

In Table 1, the column of “Mixing ratio” indicates a mixing mass ratio (a mass of the first lithium compound:a mass of the second lithium compound).

In Table 1, the column of “Intensity ratio” indicates a ratio of the Raman intensity at 1,800 cm⁻¹ to the Raman intensity at 1,000 cm⁻¹ in the Raman spectrum of the second lithium compound.

In Table 1, the column of “Coefficient of determination” of “Lithium ion conductor” indicates a coefficient of determination obtained by carrying out a linear regression analysis according to a least squares method in a wave number range of 600 to 850 cm⁻¹ of the second lithium compound (or the LBO powder for the comparative example) in the lithium ion conductor in the Raman spectrum.

TABLE 1

| | Second lithium compound | | | | LBO powder for | | | | | | |
|---|---|---|---|---|---|---|---|---|---|---|---|
| | | | Proportion | | comparative example | | | | Lithium ion conductor | | |
| | Bulk | | of full width | Coefficient | Bulk | | Coefficient | | | | Coefficient |
| | elastic | Require- | at half | of | elastic | Require- | of | | Li ion | | of |
| | modulus | ment | maximum | determin- | modulus | ment | determin- | Mixing | conductivity | Intensity | determin- |
| | (GPa) | 1 | (%) | ation | (GPa) | 1 | ation | ratio | (S/cm) | ratio | ation |
| Example 1 | 36 | A | 46 | 0.9677 | — | — | — | 8:1 | 1.3 × 10⁻⁶ | 2.13 | 0.8943 |
| Example 2 | 36 | A | 46 | 0.9677 | — | — | — | 4:1 | 1.2 × 10⁻⁵ | 1.70 | 0.9953 |
| Example 3 | 36 | A | 46 | 0.9677 | — | — | — | 2:1 | 4.3 × 10⁻⁶ | 1.67 | 0.9733 |
| Example 4 | 36 | A | 46 | 0.9677 | — | — | — | 1:1 | 3.0 × 10⁻⁶ | 1.77 | 0.9941 |
| Comparative | — | — | — | — | 47 | B | 0.1660 | 4:1 | No | 1.49 | 0.3808 |
| Example 1 | | | | | | | | | conductivity | | |

As shown in Table 1, a desired lithium ion conductor was obtained by using the composite body according to the embodiment of the present invention.

### EXPLANATION OF REFERENCES

1: negative electrode collector
2: negative electrode active material layer
3: solid electrolyte layer
4: positive electrode active material layer
5: positive electrode collector
6: operation portion
10: all-solid state lithium ion secondary battery

What is claimed is:

1. A composite body comprising:
a lithium compound having a lithium ion conductivity of 1.0×10⁻⁶ S/cm or more at 25° C.; and
lithium tetraborate that satisfies the following requirement 1,
the requirement 1: in a reduced two-body distribution function G(r) obtained from an X-ray total scattering measurement of the lithium tetraborate, a first peak in which a peak top is located in a range where r is 1.43±0.2 Å and a second peak in which a peak top is located in a range where r is 2.40+0.2 Å are present, G(r) of the peak top of the first peak and G(r) of the peak top of the second peak indicate more than 1.0, and an absolute value of G(r) is less than 1.0 in a range where r is more than 5 Å and 10 Å or less.

2. The composite body according to claim 1,
wherein a proportion of a full width at half maximum of a peak in which a frequency shift appears in a range of −100 to +100 ppm in a spectrum obtained in a case where a solid ⁷Li-NMR measurement of the lithium tetraborate is carried out at 120° C. is 70% or less with respect to a full width at half maximum of a peak in which a frequency shift appears in a range of −100 to +100 ppm in a spectrum obtained in a case where the solid ⁷Li-NMR measurement of the lithium tetraborate is carried out at 20° C.

3. The composite body according to claim 1,
wherein the lithium tetraborate has a bulk elastic modulus of 45 GPa or less.

4. The composite body according to claim 1,
wherein the lithium compound is a lithium-containing oxide.

5. The composite body according to claim 1,
wherein the lithium compound includes at least one selected from the group consisting of a lithium compound having a garnet-type structure or a garnet-type similar structure containing at least Li, La, Zr, and O; a lithium compound having a perovskite-type structure, containing at least Li, Ti, La, and O; a lithium compound having a NASICON-type structure, containing at least Li, M¹, P, and O, where M¹ represents at least one of Ti, Zr, or Ge; a lithium compound having an amorphous-type structure, containing at least Li, P, O, and N; a lithium compound having a monoclinic structure, containing at least Li, Si, and O; a lithium compound having an olivine-type structure represented by LiM²X¹O₄, where M² represents a divalent element or a trivalent element, X¹ represents a pentavalent element in a case where M² represents a divalent element, and X¹ represents a tetravalent element in a case where M² represents a trivalent element; a lithium compound having an antiperovskite structure, containing at least Li, O, and X², where X² represents at least one of Cl, Br, or N; a lithium compound having a spinel-type structure, represented by Li₂M₃Y₄, where M³ represents at least one of Cd, Mg, Mn, or V, and Y represents at least one of F, Cl, Br, or I; and a lithium compound having a P-alumina structure.

6. A lithium ion conductor formed of the composite body according to claim 1.

7. The lithium ion conductor according to claim 6,
wherein the lithium ion conductor satisfies the following requirement 2 or requirement 3,
the requirement 2: a Raman intensity of the lithium tetraborate in the lithium ion conductor at 1,800 cm⁻¹ is 1.60 times or more with respect to a Raman intensity at 1,000 cm⁻¹ in a Raman spectrum,
the requirement 3: a coefficient of determination obtained by carrying out a linear regression analysis according to a least squares method in a wave number range of 600 to 850 cm⁻¹ of the lithium tetraborate in the lithium ion conductor is 0.8900 or more in the Raman spectrum.

8. An all-solid state lithium ion secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer contains the lithium ion conductor according to claim 6.

9. An electrode sheet for an all-solid state lithium ion secondary battery comprising the lithium ion conductor according to claim 6.

10. Lithium tetraborate that satisfies the following requirement 1,
the requirement 1: in a reduced two-body distribution function G(r) obtained from an X-ray total scattering measurement of the lithium tetraborate, a first peak in which a peak top is located in a range where r is 1.43±0.2 Å and a second peak in which a peak top is located in a range where r is 2.40±0.2 Å are present, G(r) of the peak top of the first peak and G(r) of the peak top of the second peak indicate more than 1.0, and an absolute value of G(r) is less than 1.0 in a range where r is more than 5 Å and 10 Å or less.

11. The lithium tetraborate according to claim 10,
wherein a proportion of a full width at half maximum of a peak in which a frequency shift appears in a range of −100 to +100 ppm in a spectrum obtained in a case where a solid ⁷Li-NMR measurement is carried out at 120° C. is 70% or less with respect to a full width at half maximum of a peak in which a frequency shift appears in a range of −100 to +100 ppm in a spectrum obtained in a case where the solid ⁷Li-NMR measurement is carried out at 20° C.

12. The lithium tetraborate according to claim 10,
wherein a coefficient of determination obtained by carrying out a linear regression analysis according to a least squares method in a wave number range of 600 to 850 cm⁻¹ is 0.9400 or more in a Raman spectrum.

13. The composite body according to claim 2,
wherein the lithium tetraborate has a bulk elastic modulus of 45 GPa or less.

14. The composite body according to claim 2,
wherein the lithium compound is a lithium-containing oxide.

15. The composite body according to claim 2,
wherein the lithium compound includes at least one selected from the group consisting of a lithium compound having a garnet-type structure or a garnet-type similar structure containing at least Li, La, Zr, and O; a lithium compound having a perovskite-type structure, containing at least Li, Ti, La, and O; a lithium compound having a NASICON-type structure, containing at least Li, M¹, P, and O, where M¹ represents at least one of Ti, Zr, or Ge; a lithium compound having an amorphous-type structure, containing at least Li, P, O, and N; a lithium compound having a monoclinic structure, containing at least Li, Si, and O; a lithium compound having an olivine-type structure represented by LiM²X¹O₄, where M² represents a divalent element or a trivalent element, X¹ represents a pentavalent element in a case where M² represents a divalent element, and X¹ represents a tetravalent element in a case where M² represents a trivalent element; a lithium compound having an antiperovskite structure, containing at least Li, O, and X², where X² represents at least one of Cl, Br, or N; a lithium compound having a spinel-type structure, represented by Li₂M³Y₄, where M³ represents at least one of Cd, Mg, Mn, or V, and Y represents at least one of F, Cl, Br, or I; and a lithium compound having a β-alumina structure.

16. A lithium ion conductor formed of the composite body according to claim 2.

17. The lithium ion conductor according to claim 16,
wherein the lithium ion conductor satisfies the following requirement 2 or requirement 3,
the requirement 2: a Raman intensity of the lithium tetraborate in the lithium ion conductor at 1,800 cm⁻¹ is 1.60 times or more with respect to a Raman intensity at 1,000 cm⁻¹ in a Raman spectrum,
the requirement 3: a coefficient of determination obtained by carrying out a linear regression analysis according to a least squares method in a wave number range of 600 to 850 cm⁻¹ of the lithium tetraborate in the lithium ion conductor is 0.8900 or more in the Raman spectrum.

18. An all-solid state lithium ion secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer contains the lithium ion conductor according to claim 7.

19. An electrode sheet for an all-solid state lithium ion secondary battery comprising the lithium ion conductor according to claim 7.

20. The lithium tetraborate according to claim 11,
wherein a coefficient of determination obtained by carrying out a linear regression analysis according to a least squares method in a wave number range of 600 to 850 cm⁻¹ is 0.9400 or more in a Raman spectrum.
